(19) United States
(12) Patent Application Publication
(10) Pub. No.: US 2024/0390791 A1
(43) Pub. Date: Nov. 28, 2024

(54) FEATURE EXTRACTION METHOD AND APPARATUS FOR THREE-DIMENSIONAL SCENE, DEVICE, AND STORAGE MEDIUM

(71) Applicant: Tencent Technology (Shenzhen) Company Limited, Shenzhen (CN)

(72) Inventors: Zhipeng XU, Shenzhen (CN); Jingwen YANG, Shenzhen (CN); Xiaoxi WANG, Shenzhen (CN); Zihui GU, Shenzhen (CN); Le WAN, Shenzhen (CN); Jun YIN, Shenzhen (CN); Zhuoneng OUYANG, Shenzhen (CN); Dingjian JIN, Shenzhen (CN); Mingxiang LIAO, Shenzhen (CN); Zongbo LIU, Shenzhen (CN); Yuning LIANG, Shenzhen (CN); Bingquan GUAN, Shenzhen (CN); Yihao YANG, Shenzhen (CN); Jiazhong SHEN, Shenzhen (CN); Siliang LIU, Shenzhen (CN); Lina GAO, Shenzhen (CN)

(21) Appl. No.: 18/795,035

(22) Filed: Aug. 5, 2024

Related U.S. Application Data
(63) Continuation of application No. PCT/CN2023/125320, filed on Oct. 19, 2023.

(30) Foreign Application Priority Data
Dec. 1, 2022 (CN) 202211525532.8

(51) Int. Cl. A63F 13/52; A63F 13/57; A63F 13/58; G06N 20/00; G06T 15/06

(52) U.S. Cl. CPC A63F 13/52; A63F 13/57; A63F 13/58; G06N 20/00; G06T 15/06

(57) ABSTRACT

This application disclose a feature extraction method performed by a computer device. The method includes: shooting a cone-shaped group of viewing-frustum rays from a target character object for a hit object in a three-dimensional scene picture; determining object attribute information of the hit object based on an interaction between the viewing-frustum rays and the hit object; performing vector conversion on the object attribute information of the hit object, to obtain a ray-feature vector; collecting, by using a location of the target character object as a collection center, a plurality of height-value matrices corresponding to different granularities; performing feature dimension reduction on the height-value matrix corresponding to each granularity, to obtain a height-map feature vector; and integrating the ray-feature vector and the height-map feature vector into a three-dimensional scene feature.

### CROSS-REFERENCE TO RELATED APPLICATIONS

This application is a continuation application of PCT Patent Application No. PCT/CN2023/125320, entitled “FEATURE EXTRACTION METHOD AND APPARATUS FOR THREE-DIMENSIONAL SCENE, DEVICE, AND STORAGE MEDIUM” filed on Oct. 19, 2023, which claims priority to Chinese Patent Application No. 2022115255328, entitled “FEATURE EXTRACTION METHOD AND APPARATUS FOR THREE-DIMENSIONAL SCENE, DEVICE, AND STORAGE MEDIUM” filed with the China National Intellectual Property Administration on Dec. 1, 2022, both of which are incorporated by reference in their entirety.

### FIELD OF THE TECHNOLOGY

Embodiments of this application relate to the field of image processing technologies, and in particular, to a feature extraction technology for a three-dimensional scene.

### BACKGROUND OF THE DISCLOSURE

In actual application, a three-dimensional scene (for example, a three-dimensional game scene) generally has features such as being unstructured, having complicated object categories, having complex object shapes, and being difficult to be modeled as data information. Correspondingly, how to efficiently and accurately extract a scene feature of the three-dimensional scene becomes a problem currently difficult to resolve. Currently, a manner of performing feature extraction on the three-dimensional scene mainly includes extracting a visual image feature, extracting a depth-map feature, and the like.

However, it is incomplete to describe the three-dimensional scene by extracting the visual image feature. This is because the extracted visual image feature is essentially a projection of the three-dimensional scene on a two-dimensional plane, and includes only two-dimensional information of the three-dimensional scene. In addition, a data dimension of the visual image feature is high, and high learning costs are consumed when a related machine learning task is performed based on the visual image feature.

Although the depth-map feature includes three-dimensional information of the scene, a data dimension of the depth-map feature is still high. There is some duplication and redundancy in information included between pixels, and the depth-map feature includes only distance information. In a related machine learning task, high costs still need to be consumed to perform inductive learning on the depth-map feature.

Although richer scene features can be extracted when the visual image feature and the depth-map feature are combined, problems of a high data dimension of the extracted feature and high learning costs of a machine learning task still exist.

### SUMMARY

Embodiments of this application provide a feature extraction method and apparatus for a three-dimensional scene, a device, and a storage medium, which can ensure that an extracted three-dimensional scene feature is concise, efficient, and semantically rich, and can fully describe the three-dimensional scene. A machine learning task is performed based on the three-dimensional scene feature, so that a three-dimensional scene sensing capability of a machine learning model can be enhanced, production and development of the machine learning model can be accelerated, and learning costs of the machine learning task can be reduced.

According to an aspect of the embodiments of this application, a feature extraction method for a three-dimensional scene is performed by a computer device, and including:
shooting a cone-shaped group of viewing-frustum rays from a target character object for a hit object in a three-dimensional scene picture;
determining object attribute information of the hit object based on an interaction between the viewing-frustum rays and the hit object;
performing vector conversion on the object attribute information of the hit object, to obtain a ray-feature vector;
collecting, based on different granularities by using a location of the target character object as a collection center, a height-value matrix corresponding to each granularity;
performing feature dimension reduction on the height-value matrices respectively corresponding to the granularities, to obtain a height-map feature vector; and
integrating the ray-feature vector and the height-map feature vector into a three-dimensional scene feature corresponding to the three-dimensional scene picture.

Another aspect of this application provides a computer device, including: a memory, and a processor,
the memory being configured to store a computer program therein,
the computer program be configured to, when executed by the processor, causing the computer device to perform the method according to the foregoing aspect.

Another aspect of this application provides a non-transitory computer-readable storage medium, the computer-readable storage medium having instructions stored therein, the instructions, when executed by a processor of a computer device, causing the computer device to perform the method according to the foregoing aspect.

It can be seen from the foregoing technical solutions that, the embodiments of this application have the following beneficial effects.

The group of viewing-frustum rays are shot from the target character object. When the viewing-frustum ray reaches the hit object, the object attribute information of the hit object is returned, vector conversion is performed on the received object attribute information of each hit object to obtain the corresponding basic ray-feature vector, and feature dimension reduction is performed on the basic ray-feature vector to obtain the ray-feature vector. In addition, based on the different granularities by using the location of the target character object as the collection center, the height-value matrix corresponding to each granularity is collected, and feature dimension reduction is performed on the height-value matrices respectively corresponding to the granularities to obtain the height-map feature vector. Then, the ray-feature vector and the height-map feature vector are integrated into the three-dimensional scene feature corresponding to the three-dimensional scene picture.

In the foregoing manner, through the viewing-frustum rays, the object attribute information of the hit object returned by the viewing-frustum ray hitting the object can be quickly obtained. In this way, the corresponding basic ray-feature vector can be obtained through the conversion based on the object attribute information of the hit object, so that the basic ray-feature vector includes attribute information of an object in the three-dimensional scene. In addition, because a quantity of the shot viewing-frustum rays is much lower than a quantity of pixel points of a visual image feature, a depth-map feature, or the like, the obtained basic ray-feature vector is concise and non-redundant. Then, dimension reduction is performed on the basic ray-feature vector, so that a dimension of data can be further effectively reduced. In addition, the height-value matrices corresponding to the different granularities are collected, to represent a terrain height around the current target character object, and dimension reduction is performed on the height-value matrices to obtain the height-map feature vector, to effectively reduce the dimension of the data. In addition, the height-map feature vector can extract terrain landform information of the three-dimensional scene, so that the three-dimensional scene is described more completely. Then, by integrating the ray-feature vector and the height-map feature vector into the three-dimensional scene feature, the three-dimensional scene feature is not only concise, efficient, and semantically rich, but the three-dimensional scene feature also includes the terrain landform information, to fully describe the three-dimensional scene. The machine learning model is learnt based on the three-dimensional scene feature obtained through integration and used as a sample feature, so that the three-dimensional scene sensing capability of the machine learning model can be enhanced, thereby accelerating the production and development of the machine learning model, and reducing the learning costs of the machine learning task.

### BRIEF DESCRIPTION OF THE DRAWINGS

FIG. 1 is a schematic architectural diagram of an image data control system according to an embodiment of this application.

FIG. 2 is a flowchart of an embodiment of a feature extraction method for a three-dimensional scene according to an embodiment of this application.

FIG. 3 is a flowchart of another embodiment of a feature extraction method for a three-dimensional scene according to an embodiment of this application.

FIG. 4 is a flowchart of another embodiment of a feature extraction method for a three-dimensional scene according to an embodiment of this application.

FIG. 5 is a flowchart of another embodiment of a feature extraction method for a three-dimensional scene according to an embodiment of this application.

FIG. 6 is a flowchart of another embodiment of a feature extraction method for a three-dimensional scene according to an embodiment of this application.

FIG. 7 is a flowchart of another embodiment of a feature extraction method for a three-dimensional scene according to an embodiment of this application.

FIG. 8 is a flowchart of another embodiment of a feature extraction method for a three-dimensional scene according to an embodiment of this application.

FIG. 9 is a flowchart of another embodiment of a feature extraction method for a three-dimensional scene according to an embodiment of this application.

FIG. 10 is a flowchart of another embodiment of a feature extraction method for a three-dimensional scene according to an embodiment of this application.

FIG. 11 is a flowchart of another embodiment of a feature extraction method for a three-dimensional scene according to an embodiment of this application.

FIG. 12 is a flowchart of another embodiment of a feature extraction method for a three-dimensional scene according to an embodiment of this application.

FIG. 13 is a flowchart of another embodiment of a feature extraction method for a three-dimensional scene according to an embodiment of this application.

FIG. 14 is a schematic flowchart of a principle of a feature extraction method for a three-dimensional scene according to an embodiment of this application.

FIG. 15 is a schematic diagram of a principle of feature processing in a feature extraction method for a three-dimensional scene according to an embodiment of this application.

FIG. 16 is a schematic diagram of an effect of a group of shot viewing-frustum rays in a feature extraction method for a three-dimensional scene according to an embodiment of this application.

FIG. 17 is a schematic diagram of an envelope surface of a group of shot viewing-frustum rays in a feature extraction method for a three-dimensional scene according to an embodiment of this application.

FIG. 18 is a schematic diagram of cross-sectional distribution of a group of shot viewing-frustum rays when a horizontal distance for which the viewing-frustum rays are shot reaches a distance threshold in a feature extraction method for a three-dimensional scene according to an embodiment of this application.

FIG. 19 is a schematic diagram of an embodiment of a feature extraction apparatus for a three-dimensional scene according to an embodiment of this application.

FIG. 20 is a schematic diagram of an embodiment of a computer device according to an embodiment of this application.

### DESCRIPTION OF EMBODIMENTS

In the specification, claims, and the accompanying drawings of this application, the terms “first”, “second”, “third”, “fourth”, and the like (if any) are used for distinguishing between similar objects and not necessarily used for describing a particular order or sequence. Data used in this way is interchangeable in a suitable case, so that embodiments of this application described herein can, for example, be implemented in an order other than those illustrated or described herein. In addition, the terms “comprise”, “corresponding to” and any other variants are intended to cover the non-exclusive inclusion. For example, a process, method, system, product, or device that includes a series of operations or units is not necessarily limited to those expressly listed operations or units, but may include other operations or units not expressly listed or inherent to the process, method, product, or device.

For ease of understanding, some terms or concepts involved in the embodiments of this application are first explained.

1. Machine learning: Machine learning is a type of method in which a rule is automatically analyzed and obtained from a data feature and predictive inference is performed on unknown data by using the rule, and is a way to implement artificial intelligence. The machine learning includes supervised learning, unsupervised learning, semi-supervised learning, and reinforcement learning.

2. Game AI: Game AI is a program or a character introduced into a game with reference to an artificial intelligence-related technology to enrich a playing method of the game and improve game experience of a player.

3. Three-dimensional game scene: A three-dimensional game scene is a scene in which a character in a three-dimensional game is located, includes a surrounding environment, various objects, and the like, and is a set of entire spatial information.

4. Feature extraction: Feature extraction means constructing, based on an initial data information set, an informative and non-redundant derived value, referred to as a feature value. The feature extraction is a process of performing simplification and dimension reduction on original information, and can enable a machine learning model to perform induction and learning easily.

5. Visual image feature: A visual image feature is a feature obtained through using a rendered image at a visual angle of a current character in a three-dimensional scene as the feature. The rendered image generally includes three channels (RGB), and a visual effect thereof is substantially consistent with a three-dimensional scene picture visible to a user. After the visual image feature is obtained, a machine learning model (for example, game AI) generally encodes the image feature by using a convolution or attention mechanism, and a parameter for encoding is generally learnable.

6. Depth-map feature: A depth-map feature is a feature obtained through using a depth value of a pixel point at a visual angle of a current character in a three-dimensional scene as the feature. A distance between the current character and each object pixel point at the visual angle needs to be calculated. A depth value matrix may be considered as an image. Therefore, a machine learning model (for example, game AI) processes the depth-map feature in a manner similar to a manner of processing a visual image feature, and encoding is generally performed by using a convolution or attention mechanism.

In a specific implementation of this application, related data such as object attribute information is involved. When the foregoing embodiments of this application are applied to a specific product or technology, user permission or consent is required to be obtained, and relevant collection, use, and processing of data are required to comply with relevant laws, regulations, and standards of relevant countries and regions.

A feature extraction method for a three-dimensional scene provided in this application may be applied to various scenarios, including but not limited to artificial intelligence, a cloud technology, a map, intelligent transportation, and the like. The method is configured for integrating a ray-feature vector and a height-map feature vector into a three-dimensional scene feature for learning of a machine learning model, and can be applied to a game including a three-dimensional scene, such as a first-person shooting game, an arena game, or an intelligent transportation game.

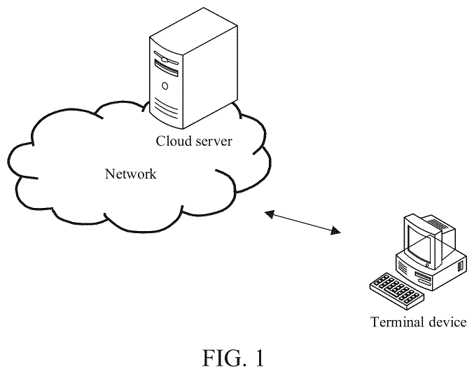

The feature extraction method for a three-dimensional scene provided in this application may be applied to an image data control system shown in FIG. 1. FIG. 1 is a schematic architectural diagram of an image data control system according to an embodiment of this application. As shown in FIG. 1, a server obtains a three-dimensional scene picture provided by a terminal device, and shoots a group of viewing-frustum rays from a target character object. When a viewing-frustum ray in the group of viewing-frustum rays reaches a hit object, object attribute information of the hit object is returned, vector conversion is performed on the received object attribute information of each hit object to obtain a basic ray-feature vector corresponding to the viewing-frustum ray, and feature dimension reduction is performed on the basic ray-feature vector to obtain a ray-feature vector. In addition, based on different granularities by using a location of the target character object as a collection center, a height-value matrix corresponding to each granularity is collected, and feature dimension reduction is performed on the height-value matrices respectively corresponding to the granularities, to obtain a height-map feature vector. Then, the ray-feature vector and the height-map feature vector are integrated into a three-dimensional scene feature corresponding to the three-dimensional scene picture.

In the foregoing manner, through the viewing-frustum rays, the object attribute information of the hit object returned by the viewing-frustum ray hitting the object can be quickly obtained. In this way, the corresponding basic ray-feature vector can be obtained through the conversion based on the object attribute information of the hit object, so that the basic ray-feature vector includes attribute information of an object in the three-dimensional scene. In addition, because a quantity of the shot viewing-frustum rays is much lower than a quantity of pixel points of a visual image feature, a depth-map feature, or the like, the obtained basic ray-feature vector is concise and non-redundant. Then, dimension reduction is performed on the basic ray-feature vector, so that a dimension of data can be further effectively reduced. In addition, the height-value matrices corresponding to the different granularities are collected, to represent a terrain height around the current target character object, and dimension reduction is performed on the height-value matrices to obtain the height-map feature vector, to effectively reduce the dimension of the data. In addition, the height-map feature vector can extract terrain landform information of the three-dimensional scene, so that the three-dimensional scene is described more completely. Then, by integrating the ray-feature vector and the height-map feature vector into the three-dimensional scene feature, the three-dimensional scene feature is not only concise, efficient, and semantically rich, but the three-dimensional scene feature also includes the terrain landform information, to fully describe the three-dimensional scene. The machine learning model is learnt based on the three-dimensional scene feature obtained through integration and used as a sample feature, so that a three-dimensional scene sensing capability of the machine learning model can be enhanced, thereby accelerating production and development of the machine learning model, and reducing learning costs of a machine learning task.

FIG. 1 shows only one terminal device. More types of terminal devices may participate in a data processing process in an actual scenario. The terminal device includes but is not limited to a mobile phone, a computer, an intelligent voice interaction device, a smart home appliance, an in-vehicle terminal, and the like. A specific quantity and type depend on the actual scenario. This is not specifically limited herein. In addition, one server is shown in FIG. 1, but in the actual scenario, a plurality of servers may participate. Particularly, in a multi-model training interaction scenario, a quantity of servers depends on the actual scenario. This is not specifically limited herein.

In this embodiment, the server may be an independent physical server, or may be a server cluster or a distributed system formed by a plurality of physical servers, or may be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The terminal device and the server may be directly or indirectly connected in a wired or wireless communication manner, and the terminal device and the server may be connected to form a blockchain network. This is not limited in this application.

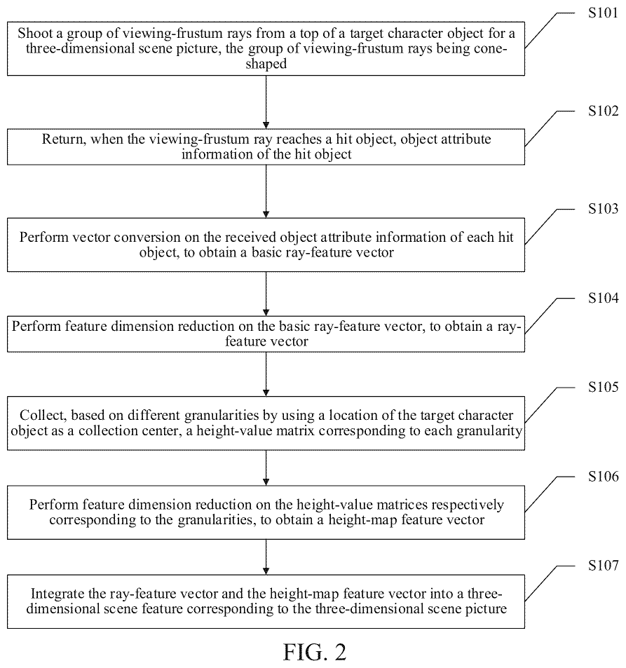

The feature extraction method for a three-dimensional scene in this application is introduced below with reference to the foregoing introduction. Referring to FIG. 2, an embodiment of the feature extraction method for a three-dimensional scene in the embodiments of this application includes the following operations.

Operation S101: Shoot a group of viewing-frustum rays from a top of a target character object for a three-dimensional scene picture, the group of viewing-frustum rays being cone-shaped.

The feature extraction method for a three-dimensional scene provided in the embodiments of this application may be configured for extracting a three-dimensional scene feature corresponding to a three-dimensional game scene picture, and the three-dimensional scene feature corresponding to the three-dimensional game scene picture may be configured for training game AI in actual application.

Because the game AI can not only provide better game experience, but can also enable game production, for example, predict a game winning rate, design a more reasonable level and value, and design a more interesting game character, designing more intelligent and comprehensive game AI is an important link in the game production. In a three-dimensional scene game, in designing the game AI, it is necessary to enable the game AI to effectively sense game scene information at a current state. However, original three-dimensional scene information has excessively high dimensions and complicated content, and is difficult to be directly used as an input of a machine learning model. Therefore, feature extraction needs to be performed on the original three-dimensional scene information. However, a three-dimensional scene in a game generally has features such as being unstructured, having complicated object categories, having complex object shapes, and being difficult to be modeled as data information.

Therefore, not only accuracy and completeness of the described three-dimensional scene information need to be maintained, but dimension reduction and simplification need to be performed on the three-dimensional scene information, to better assist machine learning game AI based on the extracted three-dimensional scene feature.

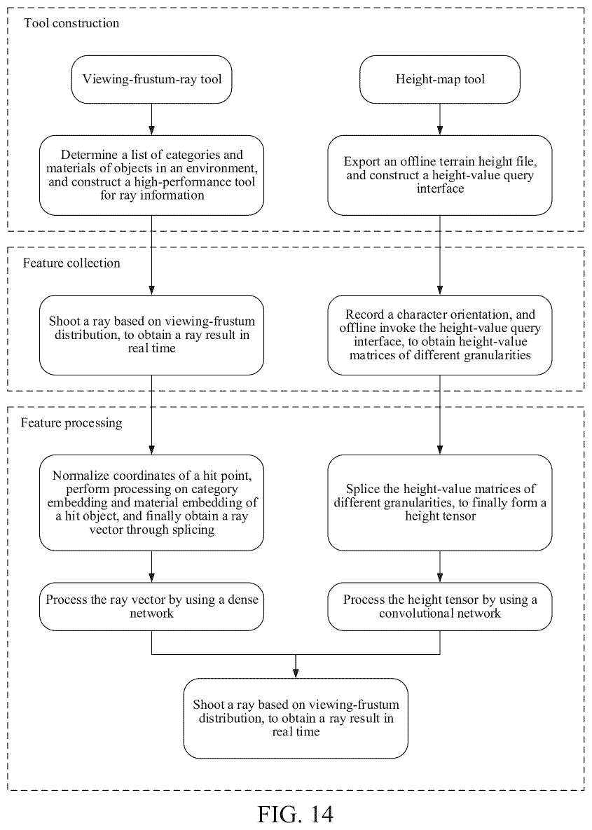

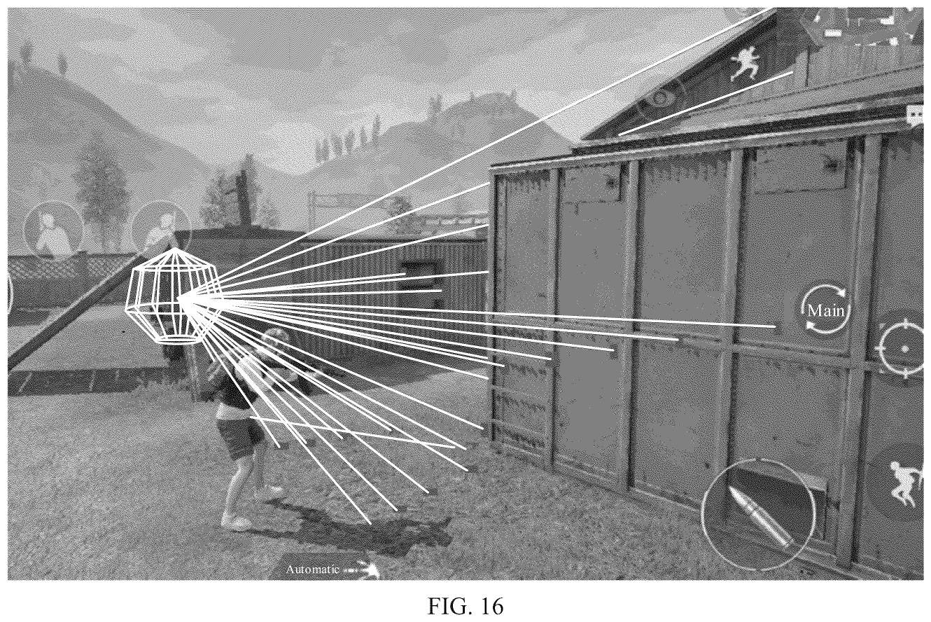

To better perform feature extraction for the three-dimensional scene, as shown in FIG. 14, tool construction may be first performed in this embodiment. For example, a viewing-frustum-ray tool, a height-map tool, and the like may be constructed. The viewing-frustum-ray tool (for example, a viewing-frustum-ray tool shown in FIG. 14) may be developed based on a natural ray function in a game engine. After each ray is shot, location information of a hit object corresponding to a hit point, and category and material information of the hit object are returned. The height-map tool (for example, a height-map tool shown in FIG. 14) needs to first export height description files (for example, height description files of various landforms such as tropical rainforests, snowfields, or islands, and height description files of terrains such as grasslands or sands) of an entire game environment (for example, a 3D FPS game shown in FIG. 16), and can provide a corresponding height-value query interface. A tool construction stage is performed only once after the game environment is determined, and the tool may be reused in the same game environment.

Further, after the viewing-frustum-ray tool and the height-map tool are constructed, a feature collection stage may be entered. For example, during a test run of a game (for example, the 3D FPS game shown in FIG. 16), for each frame of three-dimensional game scene picture, a group of viewing-frustum rays are shot from a top (for example, a head of a game character in the 3D FPS game shown in FIG. 16) of a game character object (namely, the target character object) based on viewing-frustum distribution (for example, a group of cone-shaped viewing-frustum rays are shot from the head of the game character in the 3D FPS game shown in FIG. 16) by using the viewing-frustum-ray tool (for example, the viewing-frustum-ray tool shown in FIG. 14), to obtain a ray result in real time. Because hit information of the ray needs to be dynamically calculated, feature collection of the viewing-frustum ray also needs to be performed in real time as the game progresses. A quantity and distribution of rays in the group of viewing-frustum rays may be set based on an actual need. This is not specifically limited herein.

In actual application, in addition to being used for extracting a feature of the three-dimensional game scene picture, the method provided in this embodiment of this application may alternatively be applied to another scene including the three-dimensional scene picture, to be configured for extracting a feature of the three-dimensional scene picture in the another scene. An application scenario of the method provided in this embodiment of this application is not limited herein.

Operation S102: Return, when the viewing-frustum ray reaches a hit object, object attribute information of the hit object.

In this embodiment of this application, after the group of viewing-frustum rays are shot from the target character object, if any viewing-frustum ray in the group of viewing-frustum rays hits an object in the three-dimensional scene (in this embodiment of this application, the object hit by the viewing-frustum ray is referred to as the hit object), the viewing-frustum ray hitting the object returns object attribute information corresponding to the hit point, such as the location information of the hit object, the category information of the hit object, and the material information of the hit object.

Specifically, after the feature collection stage is entered, for example, after the group of viewing-frustum rays are shot from the top of the game character object (for example, the head of the game character in the 3D FPS game shown in FIG. 16) based on the viewing-frustum distribution (for example, the group of cone-shaped viewing-frustum rays are shot from the head of the game character in the 3D FPS game shown in FIG. 16), the ray result may be obtained in real time, and if any viewing-frustum ray in the group of viewing-frustum rays hits the object in the three-dimensional game scene, the viewing-frustum ray hitting the object returns the object attribute information corresponding to the hit point to a server. For example, in the 3D FPS game shown in FIG. 16, the group of cone-shaped viewing-frustum rays are shot from the head of the game character, and it is assumed that a viewing-frustum ray hits an obstacle (for example, a container shown in FIG. 16), the viewing-frustum ray hitting the obstacle returns, to the server, object attribute information such as location information (for example, coordinates of a hit point on a box of the currently hit container on a current picture in the 3D FPS game shown in FIG. 16) of a hit object corresponding to a hit point, category information (for example, the box of the container) of the hit object, and material information (for example, high-strength steel) of the hit object.

Operation S103: Perform vector conversion on the received object attribute information of each hit object, to obtain a basic ray-feature vector.

In this embodiment of this application, after the viewing-frustum ray returns the object attribute information of the hit object, feature processing may be performed on the received object attribute information, and vector conversion is performed on all the received object attribute information of the hit object, to obtain the basic ray-feature vector, so that the three-dimensional scene feature may be better obtained based on the basic ray-feature vector subsequently.

Specifically, as shown in FIG. 14, after the object attribute information of the hit object is returned, a feature processing stage may be performed. In the feature processing stage, data obtained in the feature collection stage, namely, all the received object attribute information of the hit object, is processed and encoded, in other words, vector conversion is performed on the data, to obtain the basic ray-feature vector, so that the basic ray-feature vector can be subsequently inputted into a subsequent machine learning model for the machine learning game AI to perform inductive learning on the extracted three-dimensional scene feature. Generally, a parameter for processing and encoding is also learnable and optimizable.

Operation S104: Perform feature dimension reduction on the basic ray-feature vector, to obtain a ray-feature vector.

In this embodiment of this application, after the basic ray-feature vector is obtained, in order that a feature vector inputted into the subsequent machine learning model can be better used by the machine learning model to perform inductive learning on the extracted three-dimensional scene feature, in this embodiment, feature dimension reduction is performed on the basic ray-feature vector, to obtain a ray-feature vector with a lower dimension, to implement dimension reduction and simplification on the feature vector, so that dimension reduction and simplification on the extracted three-dimensional scene feature can be better implemented subsequently based on the ray-feature vector.

Specifically, as shown in FIG. 14, after the basic ray-feature vector is obtained, feature dimension reduction is performed on the basic ray-feature vector by using a neural network (for example, a dense network shown in FIG. 14 and used for the basic ray-feature vector), to obtain the ray-feature vector. Specifically, a one-dimensional ray-feature vector may be obtained.

Operation S105: Collect, based on different granularities by using a location of the target character object as a collection center, a height-value matrix corresponding to each granularity.

In this embodiment of this application, after the viewing-frustum-ray tool and the height-map tool are constructed, based on the different granularities by using current character coordinates of the target character object as the collection center, the height-value matrix corresponding to each granularity is collected around, so that terrain landform information in a three-dimensional environment can be better obtained based on the height-value matrix subsequently, to better assist the machine learning model in three-dimensional scene sensing.

Specifically, after the viewing-frustum-ray tool and the height-map tool are constructed, the feature collection stage may be entered. For example, during the test run of the game (for example, the 3D FPS game shown in FIG. 16), for each frame of three-dimensional game scene picture, current character coordinates (for example, a current orientation of a game character in the 3D FPS game shown in FIG. 16 and coordinates of the game character on a current picture) of the game character object in the three-dimensional game scene picture may be obtained by using the height-map tool (for example, the height-map tool shown in FIG. 14), and a terrain map corresponding to the current character coordinates is queried through a height-value query interface in the constructed height-map tool, so that by using the current character coordinates of the game character object as a collection center, based on different granularities, for example, a granularity a, a grid map corresponding to each granularity is collected around the collection center, and then a height-value matrix corresponding to each grid map is obtained based on the height-value query interface.

Because a terrain state is generally stable and does not change with game running, obtaining of the height-value matrix and extraction of a height-map feature may be offline performed, which can further reduce calculation overheads, thereby reducing development costs of the game AI to a certain extent.

Operation S106: Perform feature dimension reduction on the height-value matrices respectively corresponding to the granularities, to obtain a height-map feature vector.

In this embodiment of this application, after the height-value matrix corresponding to each granularity is obtained, in order that a feature vector inputted into the subsequent machine learning model can be better used by the machine learning model to perform inductive learning on the extracted three-dimensional scene feature, in this embodiment, feature dimension reduction may be performed on the height-value matrices respectively corresponding to the granularities, to obtain the height-map feature vector, so that the height-map feature vector can be subsequently inputted into the subsequent machine learning model for the machine learning model to perform inductive learning on the extracted three-dimensional scene feature. Generally, a parameter for processing and encoding is also learnable and optimizable.

Specifically, as shown in FIG. 14, after the height-value matrix corresponding to each granularity is obtained, feature dimension reduction is performed, by using the neural network (for example, a used convolutional network shown in FIG. 14), on the height-value matrices corresponding to all the granularities, to obtain the height-map feature vector. Specifically, a one-dimensional height feature vector may be obtained.

Operation S107: Integrate the ray-feature vector and the height-map feature vector into a three-dimensional scene feature corresponding to the three-dimensional scene picture.

In this embodiment of this application, after the ray-feature vector and the height-map feature vector are obtained, the ray-feature vector and the height-map feature vector may be integrated into the three-dimensional scene feature corresponding to the three-dimensional scene picture, so that the machine learning model may subsequently perform inductive learning on the extracted three-dimensional scene feature.

Specifically, as shown in FIG. 14, after the ray-feature vector and the height-map feature vector are obtained, the ray-feature vector and the height-map feature vector may be spliced, to obtain a three-dimensional game scene feature corresponding to the three-dimensional game scene picture. The three-dimensional game scene feature may be provided for the machine learning game AI to perform inductive learning.

This embodiment of this application provides the feature extraction method for a three-dimensional scene. In the foregoing manner, through the viewing-frustum rays, the object attribute information of the hit object returned by the viewing-frustum ray hitting the object can be quickly obtained. In this way, the corresponding basic ray-feature vector can be obtained through the conversion based on the object attribute information of the hit object, so that the basic ray-feature vector includes attribute information of an object in the three-dimensional scene. In addition, because a quantity of the shot viewing-frustum rays is much lower than a quantity of pixel points of a visual image feature, a depth-map feature, or the like, the obtained basic ray-feature vector is concise and non-redundant. Then, dimension reduction is performed on the basic ray-feature vector, so that a dimension of data can be further effectively reduced. In addition, the height-value matrices corresponding to the different granularities are collected, to represent a terrain height around the current target character object, and dimension reduction is performed on the height-value matrices to obtain the height-map feature vector, to effectively reduce the dimension of the data. In addition, the height-map feature vector can extract terrain landform information of the three-dimensional scene, so that the three-dimensional scene is described more completely. Then, by integrating the ray-feature vector and the height-map feature vector into the three-dimensional scene feature, the three-dimensional scene feature is not only concise, efficient, and semantically rich, but the three-dimensional scene feature also includes the terrain landform information, to fully describe the three-dimensional scene. The machine learning model is learnt based on the three-dimensional scene feature obtained through integration and used as a sample feature, so that a three-dimensional scene sensing capability of the machine learning model can be enhanced, thereby accelerating production and development of the machine learning model, and reducing learning costs of a machine learning task.

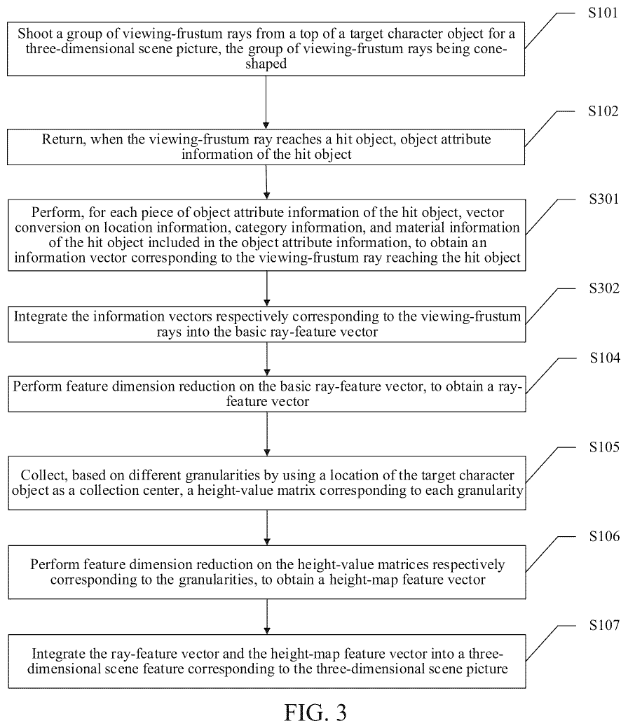

In some embodiments, based on the embodiment corresponding to FIG. 2, in another exemplary embodiment of the feature extraction method for a three-dimensional scene provided in this embodiment of this application, the object attribute information of the hit object includes location information, category information, and material information of the hit object. As shown in FIG. 3, operation S103 of performing vector conversion on the received object attribute information of each hit object, to obtain the basic ray-feature vector, includes the following operations.

Operation S301: Perform, for each piece of object attribute information of the hit object, vector conversion on the location information, the category information, and the material information of the hit object included in the object attribute information, to obtain an information vector corresponding to the viewing-frustum ray reaching the hit object.

Operation S302: Integrate the information vectors respectively corresponding to the viewing-frustum rays into the basic ray-feature vector.

In this embodiment of this application, after the object attribute information of the hit object is returned, feature processing may be performed on the received object attribute information, that is, vector conversion is performed on the location information, the category information, and the material information of the hit object, to obtain the information vector corresponding to the viewing-frustum ray hitting the hit object, and information vectors corresponding to all viewing-frustum rays hitting the object are integrated into the basic ray-feature vector, so that the three-dimensional scene feature may be better obtained based on the basic ray-feature vector subsequently.

Specifically, as shown in FIG. 14, after the object attribute information of the hit object is returned, the feature processing stage may be performed. In the feature processing stage, data obtained in the feature collection stage, namely, the location information, the category information, and the material information of the hit object corresponding to the viewing-frustum ray hitting the object, is processed and encoded, in other words, vector conversion is performed on the data, to obtain the information vector corresponding to the viewing-frustum ray. Then, the information vectors corresponding to all the viewing-frustum rays hitting the object may be spliced, to obtain the basic ray-feature vector, so that the basic ray-feature vector may be subsequently inputted into the subsequent machine learning model, for the machine learning game AI to perform inductive learning on the extracted three-dimensional scene feature.

In this way, in the foregoing manner, vector conversion is performed on the location information, the category information, and the material information of the hit object of the viewing-frustum ray, to obtain the information vector corresponding to the viewing-frustum ray, and then the information vectors respectively corresponding to the viewing-frustum rays hitting the object are integrated, to obtain the basic ray-feature vector, which can ensure that the obtained basic ray-feature vector more accurately describes an object existing in the three-dimensional scene, in other words, implements a full description of the three-dimensional scene.

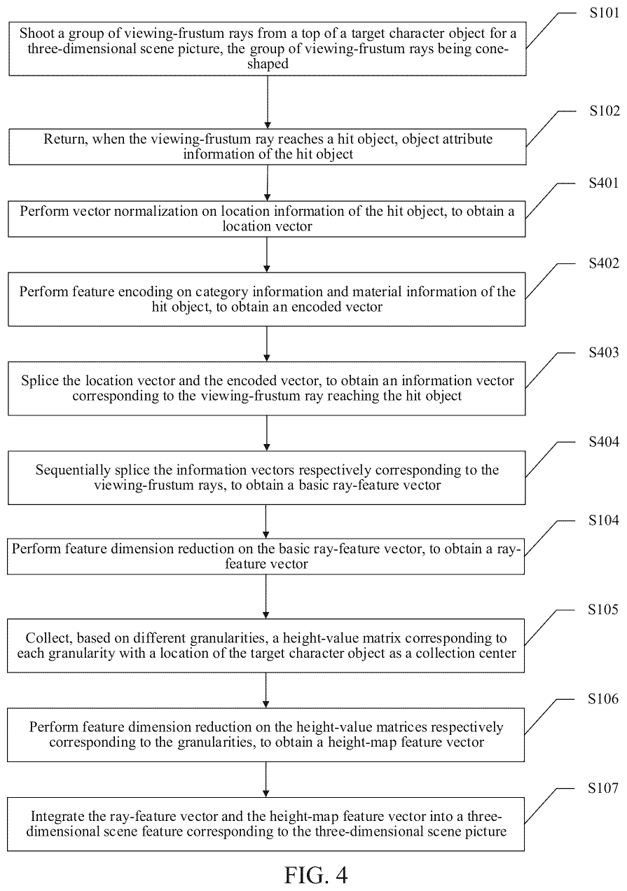

In some embodiments, based on the embodiment corresponding to FIG. 3, in another exemplary embodiment of the feature extraction method for a three-dimensional scene provided in the embodiments of this application, as shown in FIG. 4, operation S301 of performing vector conversion on the location information, the category information, and the material information of the hit object, to obtain the information vector corresponding to the viewing-frustum ray reaching the hit object includes operations S401 to S403; and operation S302 includes operation S404.

Operation S401: Perform vector normalization on the location information of the hit object, to obtain a location vector.

Operation S402: Perform feature encoding on the category information and the material information of the hit object, to obtain an encoded vector.

Operation S403: Splice the location vector and the encoded vector, to obtain the information vector corresponding to the viewing-frustum ray reaching the hit object.

Operation S404: Sequentially splice the information vectors respectively corresponding to the viewing-frustum rays, to obtain the basic ray-feature vector.

In this embodiment of this application, after the object attribute information of the hit object is returned, feature processing may be performed on the received object attribute information, that is, vector normalization is performed on the location information of the hit object to obtain the location vector, and feature encoding is performed on the category information and the material information of the hit object to obtain the encoded vector. In this way, the location vector and the encoded vector may be spliced, to obtain the information vector corresponding to the viewing-frustum ray reaching the hit object. Then, the information vectors corresponding to all the viewing-frustum rays hitting the object may be sequentially spliced, to obtain the ray-feature vector.

Specifically, as shown in FIG. 14, after the object attribute information of the hit object is returned, the feature processing stage may be performed. In the feature processing stage, data obtained in the feature collection stage is processed, where vector normalization is performed on the location information of the hit object. Specifically, a series of operations such as three-dimensional coordinate translation, scaling, and rotation are performed on coordinate information of a hit point of the viewing-frustum ray first, to obtain a location vector corresponding to the coordinate information. Alternatively, normalization may be performed on the coordinate information, for example, vector transformation is performed on the coordinate information based on a linear function (for example, matrix multiplication, for example, matrix formed by a basis vector*coordinate value=vector), to obtain the location vector corresponding to the coordinate information. Another vector normalization manner may be alternatively used. This is not specifically limited herein.

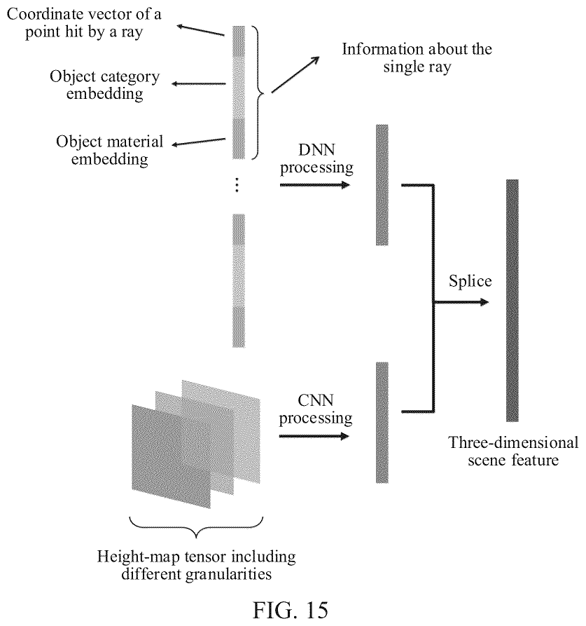

Further, feature encoding may be specifically performed on the category information and the material information of the hit object by using one-hot encoding separately on the category information and the material information. In this way, embedding processing may be performed on encoded data, to obtain an embedding vector (for example, object category embedding shown in FIG. 15) corresponding to the category information and an embedding vector (for example, object material embedding shown in FIG. 15) corresponding to the material information. Then, the embedding vector (for example, the object category embedding shown in FIG. 15) corresponding to the category information and the embedding vector (for example, the object material embedding shown in FIG. 15) corresponding to the material information are spliced into the encoded vector. Alternatively, another feature encoding manner may be alternatively used separately on the category information and the material information. This is not specifically limited herein.

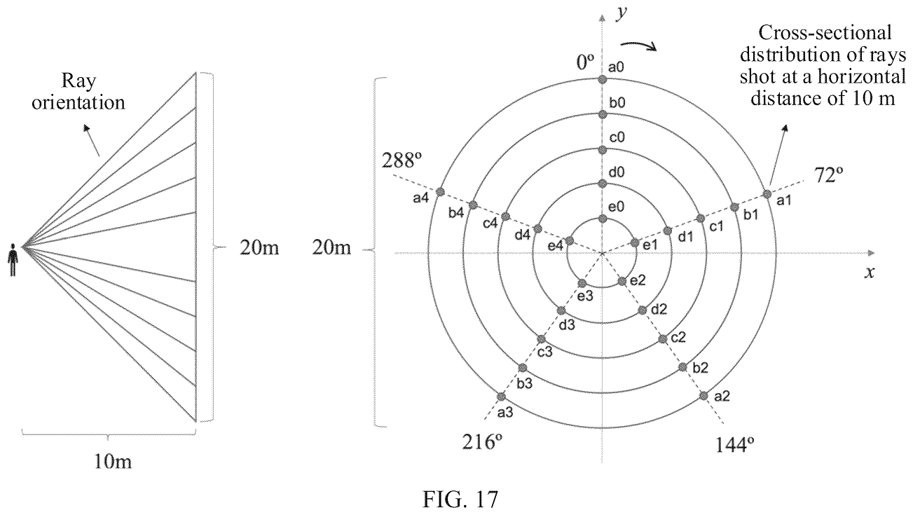

Further, as shown in FIG. 15, after the location vector (for example, a ray hit point coordinate vector shown in FIG. 15) corresponding to the location information of the hit object and the encoded vector (for example, the object category embedding and the object material embedding shown in FIG. 15) corresponding to the category information and the material information of the hit object are obtained, the location vector and the encoded vector may be spliced (for example, the ray hit point coordinate vector, the object category embedding, and the object material embedding shown in FIG. 15 are sequentially spliced), to obtain an information vector (for example, information about a single ray shown in FIG. 15) of a single viewing-frustum ray (namely, the viewing-frustum ray hitting the hit object). Then, the information vectors corresponding to all the viewing-frustum rays hitting the object are spliced in a preset fixed order (for example, for a group of viewing-frustum rays shown in a right figure of FIG. 17, splicing may be performed in a counterclockwise order first and then in an outside-to-inside order), and the basic ray-feature vector may be obtained, so that the basic ray-feature vector may be subsequently inputted into the subsequent machine learning model, for the machine learning model to perform inductive learning on the extracted three-dimensional scene feature.

In this way, in the foregoing manner, the location vector is generated based on the location information of the hit object of the viewing-frustum ray, and the encoded vector is generated based on the category information and the material information of the hit object, so that the location vector and the encoded vector are spliced to obtain the information vector corresponding to the viewing-frustum ray, and the information vectors respectively corresponding to the viewing-frustum rays of the hit object are then sequentially spliced, to obtain the basic ray-feature vector, which can ensure that the obtained basic ray-feature vector more accurately describes an object existing in the three-dimensional scene, in other words, implements a full description of the three-dimensional scene.

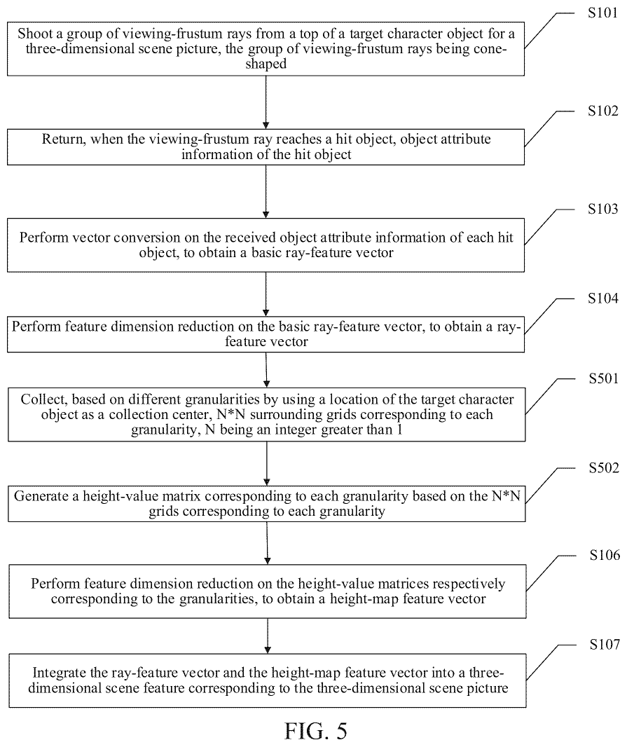

In some embodiments, based on the embodiment corresponding to FIG. 2, in another exemplary embodiment of the feature extraction method for a three-dimensional scene provided in the embodiments of this application, as shown in FIG. 5, operation S105 of collecting, based on the different granularities by using the location of the target character object as the collection center, the height-value matrix corresponding to each granularity includes the following operations.

Operation S501: Collect, based on the different granularities by using the location of the target character object as the collection center, N*N surrounding grids corresponding to each granularity, N being an integer greater than 1.

Operation S502: Generate the height-value matrix corresponding to each granularity based on the N*N grids corresponding to each granularity.

In this embodiment of this application, after the viewing-frustum-ray tool and the height-map tool are constructed, based on the different granularities by using the current character coordinates of the target character object as the collection center, the N*N surrounding grids corresponding to each granularity may be collected, and then the height-value matrix corresponding to each granularity is generated based on the N*N grids corresponding to each granularity, so that the terrain landform information in the three-dimensional environment can be better obtained based on the height-value matrix subsequently, to better assist the machine learning model in three-dimensional scene sensing.

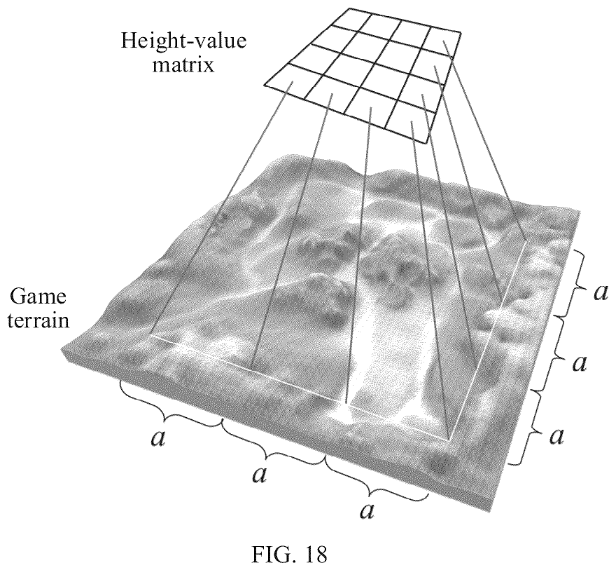

Specifically, after the viewing-frustum-ray tool and the height-map tool are constructed, the feature collection stage may be entered. For example, during the test run of the game (for example, the 3D FPS game shown in FIG. 16), for each frame of three-dimensional game scene picture, the current character coordinates (for example, the current orientation of the game character in the 3D FPS game shown in FIG. 16 and the coordinates of the game character on the current picture) of the target character object in the three-dimensional game scene picture may be obtained by using the height-map tool (for example, the height-map tool shown in FIG. 14), and the terrain map (for example, a game terrain shown in FIG. 18) corresponding to the current character coordinates is queried through the height-value query interface in the constructed height-map tool, so that by using the current character coordinates of the target character object as the collection center, and with the different granularities (for example, the granularity a) as grid side lengths, the grid map (for example, 4×4 collected grids with a as the grid side length shown in FIG. 18) corresponding to each granularity is collected around the collection center, and then a height value corresponding to the N*N grids (for example, the 4×4 collected grids with a as the grid side length shown in FIG. 18) corresponding to each granularity is obtained based on the height-value query interface, to generate the height-value matrix (for example, a 4×4 height-value matrix shown in FIG. 18).

In this way, in the foregoing manner, by using the current character coordinates of the target character object as the collection center, the N*N surrounding grids corresponding to the different granularities are collected, and the height-value matrix corresponding to each granularity is generated based on the N*N grids corresponding to each granularity. The terrain height around the current target character object may be represented by using the height-value matrices corresponding to the different granularities, and the terrain landform information of the three-dimensional scene is extracted, so that the description of the three-dimensional scene is more complete.

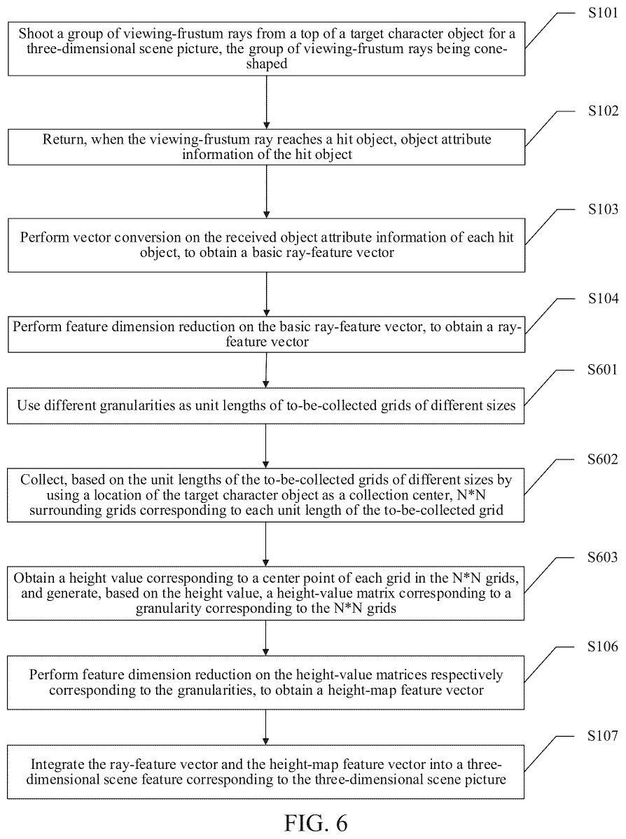

In some embodiments, based on the embodiment corresponding to FIG. 5, in another exemplary embodiment of the feature extraction method for a three-dimensional scene provided in the embodiments of this application, as shown in FIG. 6, operation S501 of collecting, based on the different granularities by using the location of the target character object as the collection center, the N*N surrounding grids corresponding to each granularity includes operations S601 and S602; and operation S502 includes operation S603.

Operation S601: Use the different granularities as unit lengths of to-be-collected grids of different sizes.

Operation S602: Collect, based on the unit lengths of the to-be-collected grids of different sizes by using the location of the target character object as the collection center, N*N surrounding grids corresponding to each unit length of the to-be-collected grid.

Operation S603: Obtain a height value corresponding to a center point of each grid in the N*N grids, and generate, based on the height value, the height-value matrix corresponding to the granularity corresponding to the N*N grids.

In this embodiment of this application, after the viewing-frustum-ray tool and the height-map tool are constructed, the different granularities may be used as the unit lengths of the to-be-collected grids of different sizes. Based on the unit lengths of the to-be-collected grids of different sizes by using the current character coordinates of the target character object as the collection center, the N*N surrounding grids corresponding to each unit length of the to-be-collected grid is collected, and then the height value corresponding to the center point of each grid in the N*N grids may be obtained, and the height-value matrix corresponding to each granularity is generated based on the height value, so that the terrain landform information in the three-dimensional environment can be better obtained based on the height-value matrix subsequently, to better assist the machine learning model in three-dimensional scene sensing.

Specifically, after the viewing-frustum-ray tool and the height-map tool are constructed, the feature collection stage may be entered. For example, during the test run of the game (for example, the 3D FPS game shown in FIG. 16), for each frame of three-dimensional game scene picture, the current character coordinates (for example, the current orientation of the game character in the 3D FPS game shown in FIG. 16 and the coordinates of the game character on the current picture) of the target character object in the three-dimensional game scene picture may be obtained by using the height-map tool (for example, the height-map tool shown in FIG. 14), and the terrain map (for example, the game terrain shown in FIG. 18) corresponding to the current character coordinates is queried through the height-value query interface in the constructed height-map tool.

Further, the different granularities (for example, the granularity a shown in FIG. 18) may be used as the unit lengths (for example, a unit length a of a to-be-collected grid shown in FIG. 18) of the to-be-collected grids of different sizes, and then based on the unit lengths (for example, the unit length of the to-be-collected grid shown in FIG. 18) of the to-be-collected grids of different sizes by using the current character coordinates of the target character object as the collection center, the grid map (for example, 4×4 collected grids with a as the grid side length shown in FIG. 18) corresponding to each granularity is collected around the collection center.

Further, the height value corresponding to the center point (for example, a center point of each grid in the 4×4 collected grids with a as the grid side length shown in FIG. 18) of each grid in the N*N grids corresponding to each granularity may be obtained based on the height-value query interface, and then the height-value matrix is generated according to a one-to-one correspondence between the center point of each grid in the N*N grids corresponding to each granularity and a location of each element in an N*N height-value matrix (for example, the height value corresponding to the center point of each grid in the N*N grids corresponding to each granularity is correspondingly filled into the 4×4 height-value matrix, to obtain the 4×4 height-value matrix shown in FIG. 18).

In this way, in the foregoing manner, the unit lengths of the to-be-collected grids of different sizes are determined for the different granularities, and collection of the N*N grids is accordingly performed, so that the height value of the center point of each grid in the N*N grids is filled into the corresponding N*N matrix, to obtain the height-value matrix corresponding to the granularity, thereby ensuring that the determined height-value matrix more accurately reflects the terrain height around the current target character object.

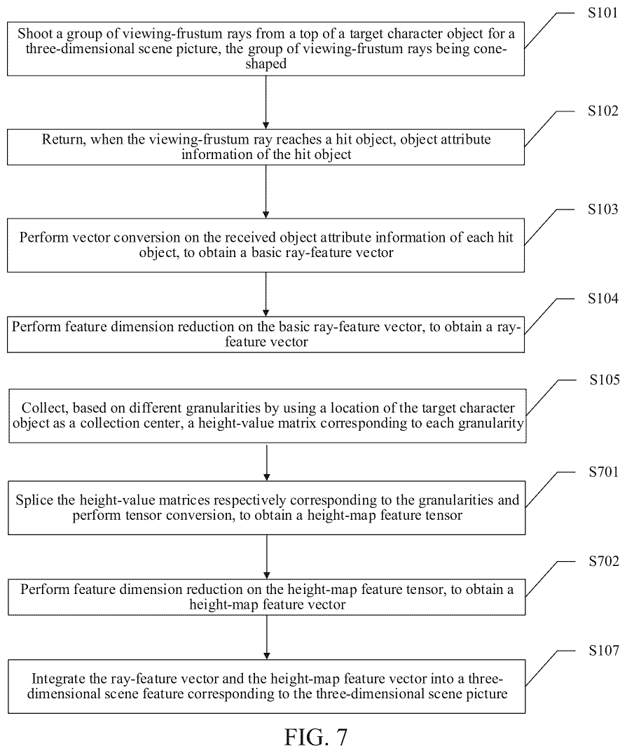

In some embodiments, based on the embodiment corresponding to FIG. 2, in another exemplary embodiment of the feature extraction method for a three-dimensional scene provided in the embodiments of this application, as shown in FIG. 7, operation S106 of performing feature dimension reduction on the height-value matrices respectively corresponding to the granularities, to obtain the height-map feature vector includes the following operations.

Operation S701: Splice the height-value matrices respectively corresponding to the granularities and perform tensor conversion, to obtain a height-map feature tensor.

Operation S702: Perform feature dimension reduction on the height-map feature tensor, to obtain the height-map feature vector.

In this embodiment of this application, after the height-value matrix corresponding to each granularity is obtained, in order that the feature vector inputted into the subsequent machine learning model can be better used by the machine learning model to perform inductive learning on the extracted three-dimensional scene feature, in this embodiment, feature dimension reduction may be performed on the height-value matrices corresponding to all the granularities, to obtain the height-map feature vector (for example, the one-dimensional height-map feature vector). Generally, a parameter for processing and encoding is also learnable and optimizable.

Specifically, as shown in FIG. 15, after the height-value matrix corresponding to each granularity (for example, height-value matrices corresponding to three different granularities shown in FIG. 15) is obtained, the height-value matrices corresponding to all the granularities are spliced and tensor conversion is performed. For example, it is assumed that there are height-value matrices corresponding to three different granularities a, b, and c. Because the three height-value matrices are 4×4 height-value matrices with a same quantity of rows and columns, matrix zero padding does not need to be performed to obtain matrices with the same quantity of rows and columns, so that transverse direction splicing or merging of arrays may be performed by using a cat function to obtain a spliced or merged matrix. Another manner of splicing or merging may be alternatively used. This is not specifically limited herein. Then, tensor conversion may be performed on the spliced or merged matrix. For example, the spliced or merged matrix may be first converted into data of a numpy type by using a numpy array, and then by using a torch. from_numpy function, for example, by substitution into a function formula: torch.from_numpy (np_array), the height-map feature tensor (for example, a height-map feature tensor including different fine granularities shown in FIG. 15) is generated by using the data of the numpy type obtained through the conversion. Another tensor conversion manner, for example, using a torch.tensor function, may be alternatively used. This is not specifically limited herein.

Further, after the height-map feature tensor (for example, the height-map feature tensor including different fine granularities shown in FIG. 15) is obtained, feature dimension reduction may be performed on the height-map feature tensor (for example, the height-map feature tensor including different fine granularities shown in FIG. 15) by using the neural network (the used convolutional network CNN shown in FIG. 14), to obtain the height-map feature vector.

To expand a sensing range for a feature, in this embodiment, height-value matrices corresponding to different receptive fields are obtained by selecting collection granularities of different sizes, so that a terrain landform of the 3D scene can be more fully described based on a height map tensor formed by the height-value matrices corresponding to different receptive fields.

In some embodiments, based on the embodiment corresponding to FIG. 2, operation S104 of performing feature dimension reduction on the basic ray-feature vector, to obtain the ray-feature vector may specifically include: performing feature dimension reduction on the basic ray-feature vector by using a neural network, to obtain the ray-feature vector. Operation S106 of performing feature dimension reduction on the height-value matrices respectively corresponding to the granularities, to obtain the height-map feature vector may specifically include: performing, by using a neural network, feature dimension reduction on the height-value matrices respectively corresponding to the granularities, to obtain the height-map feature vector.

In this way, feature dimension reduction on the basic ray-feature vector and feature dimension reduction on the height-value matrices respectively corresponding to the granularities are completed by using the corresponding neural networks, which can ensure that the ray-feature vector obtained through feature dimension reduction better retains effective information in the original basic ray-feature vector, and ensure that the height-map feature vector obtained through feature dimension reduction better retains effective information in the height-value matrices respectively corresponding to the granularities, so that the ray-feature vector and the height-map feature vector can more accurately describe the corresponding three-dimensional scene.

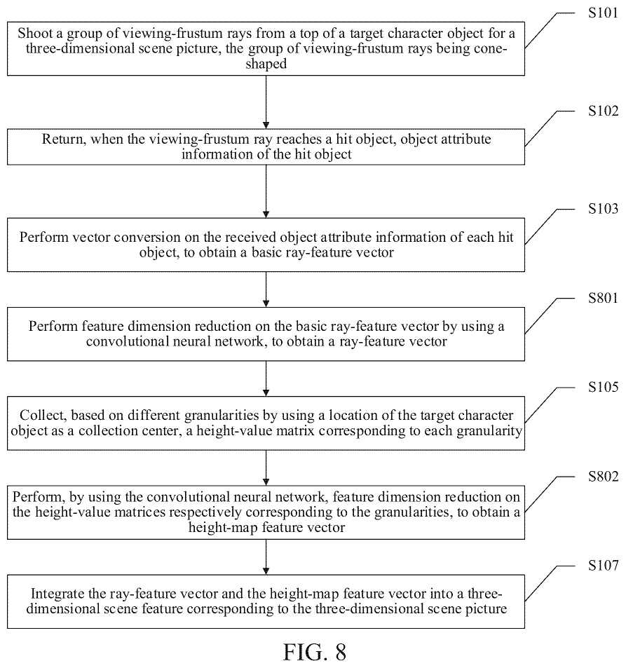

In some embodiments, based on the embodiment corresponding to FIG. 2, in another exemplary embodiment of the feature extraction method for a three-dimensional scene provided in the embodiments of this application, as shown in FIG. 8, the neural network processing the basic ray-feature vector and the neural network processing the height-value matrices (which may be specifically the height-map feature tensor) respectively corresponding to the granularities may be a same convolutional neural network; operation S104 of performing feature dimension reduction on the basic ray-feature vector, to obtain the ray-feature vector includes operation S801; and operation S106 of performing feature dimension reduction on the height-value matrices respectively corresponding to the granularities, to obtain the height-map feature vector includes operation S802.

Operation S801: Perform feature dimension reduction on the basic ray-feature vector by using the convolutional neural network, to obtain the ray-feature vector.

Operation S802: Perform, by using the convolutional neural network, feature dimension reduction on the height-value matrices respectively corresponding to the granularities, to obtain the height-map feature vector.

In this embodiment of this application, after the basic ray-feature vector and the height-map feature tensor (generated based on the height-value matrices respectively corresponding to the granularities) are obtained, the neural networks used when dimension reduction is performed on the basic ray-feature vector and the height-map feature tensor separately may be the same convolutional neural network. To be specific, feature dimension reduction is performed on the basic ray-feature vector by using the convolutional neural network, to obtain the one-dimensional ray-feature vector, and feature dimension reduction is performed on the height-map feature tensor by using the convolutional neural network, to obtain the one-dimensional height-map feature vector. This can reduce construction and use of different neural network frameworks, and can reduce a calculation amount to a certain extent, thereby improving efficiency of obtaining the three-dimensional game scene feature.

Specifically, after the basic ray-feature vector and the height-map feature tensor are obtained, dimension reduction may be performed on the basic ray-feature vector and the height-map feature tensor separately, so that a simplified and dimension-reduced three-dimensional scene feature may be better obtained based on a dimension-reduced ray-feature vector and a dimension-reduced height-map feature vector subsequently. Therefore, the neural networks used when dimension reduction is performed on the basic ray-feature vector and the height-map feature tensor separately may be the same convolutional neural network. To be specific, feature dimension reduction is performed on the basic ray-feature vector by using the convolutional neural network. Because the basic ray-feature vector is a feature vector obtained through feature normalization and splicing in a fixed order, the basic ray-feature vector may be convolved by using a 1×N convolution kernel in the convolutional neural network based on a size of a feature value, to obtain the one-dimensional ray-feature vector. That feature dimension reduction is performed on the height-map feature tensor by using the convolutional neural network may be performed by using a conventional convolution operation manner. To be specific, processing is performed through a convolution layer, a pooling layer, a fully connected layer, and the like sequentially, to obtain the one-dimensional height-map feature vector.

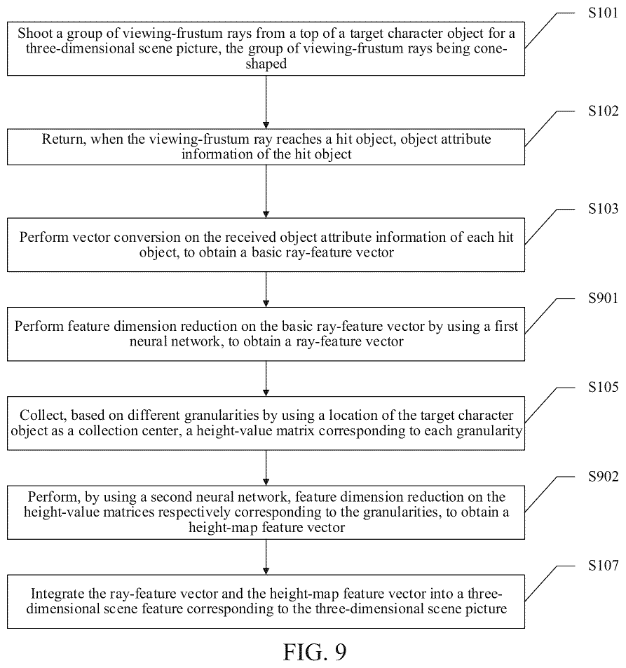

In some embodiments, based on the embodiment corresponding to FIG. 2, in another exemplary embodiment of the feature extraction method for a three-dimensional scene provided in the embodiments of this application, as shown in FIG. 9, the neural network may include a first neural network and a second neural network, and the first neural network and the second neural network are different neural networks; operation S104 of performing feature dimension reduction on the basic ray-feature vector, to obtain the ray-feature vector includes operation S901; and operation S106 of performing feature dimension reduction on the height-value matrices respectively corresponding to the granularities, to obtain the height-map feature vector includes operation S902.

Operation S901: Perform feature dimension reduction on the basic ray-feature vector by using the first neural network, to obtain the ray-feature vector.

Operation S902: Perform, by using the second neural network, feature dimension reduction on the height-value matrices respectively corresponding to the granularities, to obtain the height-map feature vector.

In this embodiment of this application, after the basic ray-feature vector and the height-map feature tensor (generated based on the height-value matrices respectively corresponding to the granularities) are obtained, the neural networks used when dimension reduction is performed on the basic ray-feature vector and the height-map feature tensor separately may be different neural networks. To be specific, feature dimension reduction is performed on the basic ray-feature vector by using the first neural network, to obtain the ray-feature vector, and feature dimension reduction is performed, by using the second neural network, on the height-value matrices corresponding to all the granularities, to obtain the height-map feature vector. Dimension reduction can be performed by using different neural networks for different types of feature vectors, so that a corresponding dimension reduction feature can be obtained better, more accurately, and more specifically, thereby improving accuracy of obtaining the three-dimensional scene feature.

The first neural network and the second neural network are different neural networks. The first neural network may be specifically represented as a dense network, for example, a DNN neural network shown in FIG. 15. The second neural network model may be specifically represented as a convolutional neural network, for example, a CNN neural network shown in FIG. 15.

Specifically, as shown in FIG. 15, after the basic ray-feature vector and the height-map feature tensor are obtained, dimension reduction may be performed on the basic ray-feature vector and the height-map feature tensor separately, so that a simplified and dimension-reduced three-dimensional scene feature may be better obtained based on a dimension-reduced ray-feature vector and a dimension-reduced height-map feature vector subsequently. Therefore, the neural networks used when dimension reduction is performed on the basic ray-feature vector and the height-map feature tensor separately may be different neural networks. Because the obtained basic ray-feature vector is non-image data, and the convolutional neural network is more convenient to learn information about an adjacent location in image data, for a ray-feature vector that does not necessarily include the information about the adjacent location, feature dimension reduction may be performed on the basic ray-feature vector by using the dense network, namely, the first neural network, for example, the DNN neural network shown in FIG. 15. Data related to an atomic location in the basic ray-feature vector may be analyzed by using a multilayer perceptron (MLP), and then a forward propagation algorithm is used on sensed data, to obtain the one-dimensional ray-feature vector. Because the height-map feature tensor belongs to the image data, feature dimension reduction may be performed on the height-map feature tensor by using the convolutional neural network that is more convenient to learn the information about the adjacent location in the image data, namely, the second neural network. To be specific, a conventional convolution operation manner may be used. To be specific, processing is performed through a convolution layer, a pooling layer, a fully connected layer, and the like sequentially, to obtain the one-dimensional height-map feature vector.

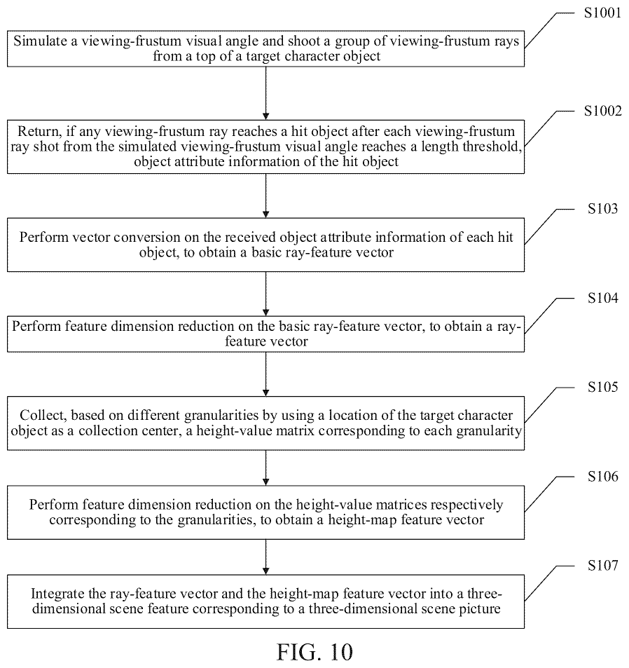

In some embodiments, based on the embodiment corresponding to FIG. 2, in another exemplary embodiment of the feature extraction method for a three-dimensional scene provided in the embodiments of this application, as shown in FIG. 10, operation S101 of shooting the group of viewing-frustum rays from the target character object includes operation S1001; and operation S102 includes operation S1002.

Operation S1001: Simulate a viewing-frustum visual angle and shoot the group of viewing-frustum rays from a top of the target character object.

Operation S1002: Return, if any viewing-frustum ray reaches the hit object after each viewing-frustum ray shot from the simulated viewing-frustum visual angle reaches a length threshold, the object attribute information of the hit object.

In this embodiment of this application, when feature extraction is performed on the original three-dimensional scene information, because the three-dimensional scene generally has features such as being unstructured, having complicated object categories, having complex object shapes, and being difficult to be modeled as data information, in this embodiment, the viewing-frustum visual angle may be simulated and the group of viewing-frustum rays may be shot from the top of the target character object. If any viewing-frustum ray reaches the hit object after each viewing-frustum ray in the group of viewing-frustum rays shot from the simulated viewing-frustum visual angle reaches the length threshold, the object attribute information of the hit object may be returned, to better sense an object arranged in the three-dimensional environment and attribute information of the object, so that the three-dimensional scene feature can be better extracted based on the object attribute information subsequently, so that machine learning can be better assisted based on the extracted three-dimensional scene feature.

Specifically, to better sense the object arranged in the three-dimensional environment and the attribute information of the object, as shown in FIG. 14, in this embodiment, tool construction may be first performed, for example, the viewing-frustum-ray tool, the height-map tool, and the like may be first constructed. Then, after the viewing-frustum-ray tool and the height-map tool are constructed, the feature collection stage may be entered. For example, during the test run of the game (for example, the 3D FPS game shown in FIG. 16), for each frame of three-dimensional game scene picture, the viewing-frustum visual angle may be simulated and the group of viewing-frustum rays may be shot from the top (for example, the head of the game character in the 3D FPS game shown in FIG. 16) of the target character object by using the viewing-frustum-ray tool (for example, the viewing-frustum-ray tool shown in FIG. 14). To be specific, a viewing-frustum ray orientation and viewing-frustum ray distribution are shown in a left figure of FIG. 17, and a group of viewing-frustum rays with an envelope surface in a cone shape are shot, to obtain a ray result in real time.

Further, after each viewing-frustum ray in the group of viewing-frustum rays shot from the simulated viewing-frustum visual angle reaches the length threshold (10 m shown in the left figure of FIG. 17), if any viewing-frustum ray hits an object, object attribute information of the hit object may be returned. For example, when any viewing-frustum ray in the group of viewing-frustum rays (the group of viewing-frustum rays with the envelope surface in the cone shape shot from the head of the game character shown in the left figure of FIG. 17) hits an object, the viewing-frustum ray hitting the object returns object attribute information corresponding to a hit point to the server. For example, in the 3D FPS game shown in FIG. 16, a group of cone-shaped viewing-frustum rays (the group of viewing-frustum rays with the envelope surface in the cone shape shot from the head of the game character shown in the left figure of FIG. 17) are shot from the head of the game character, and when each viewing-frustum ray in the group of viewing-frustum rays shot from the simulated viewing-frustum visual angle reaches the length threshold (10 m shown in the left figure of FIG. 17), it is assumed that one ray hits an object (a grassland shown in FIG. 16) at 10 m, and the viewing-frustum ray hitting the object returns object attribute information such as location information (for example, coordinates of a hit point on the currently hit grassland on a current picture in the 3D FPS game shown in FIG. 16) of the hit object corresponding to the hit point, category information (for example, ground of the grassland) of the hit object, and material information (for example, soil or a soft soil texture) of the hit object to the server.

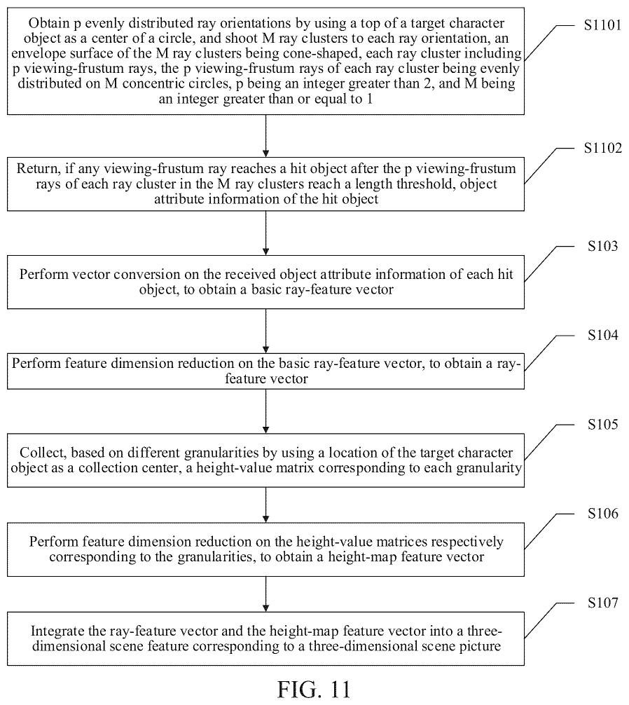

In some embodiments, based on the embodiment corresponding to FIG. 10, in another exemplary embodiment of the feature extraction method for a three-dimensional scene provided in the embodiments of this application, as shown in FIG. 11, operation S1001 of simulating the viewing-frustum visual angle and shooting the group of viewing-frustum rays from the top of the target character object includes operation S1101; and operation S1002 includes operation S1102.

Operation S1101: Obtain p evenly distributed ray orientations by using the top of the target character object as a center of a circle, and shoot M ray clusters to each ray orientation, an envelope surface of the M ray clusters being cone-shaped, each ray cluster including p viewing-frustum rays, the p viewing-frustum rays of each ray cluster being evenly distributed on M concentric circles, p being an integer greater than 2, and M being an integer greater than or equal to 1.

Operation S1102: Return, if any viewing-frustum ray reaches the hit object after the p viewing-frustum rays of each ray cluster in the M ray clusters reach the length threshold, the object attribute information of the hit object.

In this embodiment of this application, when feature extraction is performed on the original three-dimensional scene information, because the three-dimensional scene generally has features such as being unstructured, having complicated object categories, having complex object shapes, and being difficult to be modeled as data information, in this embodiment, by using the top of the target character object as the center of the circle, the p evenly distributed ray orientations may be first obtained, and then the M ray clusters are shot to each ray orientation. Then, if any viewing-frustum ray hits an object after the p viewing-frustum rays of each ray cluster in the M ray clusters reach the length threshold, object attribute information of the hit object may be returned, to better sense an object arranged in an environment and attribute Information of the object, so that the three-dimensional scene feature can be better extracted based on the object attribute information subsequently, so that machine learning can be better assisted based on the extracted three-dimensional scene feature.

The ray cluster is a ray group including the p viewing-frustum rays. The p viewing-frustum rays of one shot ray cluster may be evenly distributed on a circle. In other words, the shot M ray clusters may be evenly distributed on the M concentric circles, so that the envelope surface of the M ray clusters is cone-shaped.

Specifically, to better sense the object arranged in the three-dimensional environment and the attribute information of the object, as shown in FIG. 14, in this embodiment, tool construction may be first performed, for example, the viewing-frustum-ray tool, the height-map tool, and the like may be first constructed. Then, after the viewing-frustum-ray tool and the height-map tool are constructed, the feature collection stage may be entered. For example, during the test run of the game (for example, the 3D FPS game shown in FIG. 16), for each frame of three-dimensional game scene picture, the p evenly distributed ray orientations may be first obtained by using the viewing-frustum-ray tool (for example, the viewing-frustum-ray tool shown in FIG. 14) from the top of the target character object (for example, the head of the game character in the 3D FPS game shown in FIG. 16) as the center of the circle. I′'s assumed that p and M are both 5, in other words, 25 viewing-frustum rays are shot (when p is 5 and M is 3, 15 viewing-frustum rays are shot; when p is 5 and M is 7, 35 viewing-frustum rays are shot; or the like). To be evenly distributed on the circle, the circle may be divided into 0°, 72°, 144°, 216°, and 288°, and it is assumed that the length threshold is 10 m shown in the left figure of FIG. 17. Then, a maximum radius of the concentric circle may be obtained to be 10 m. In order that the shot M ray clusters can be evenly distributed on M concentric circles, radii of the concentric circles may be 2 m, 4 m, 6 m, 8 m, and 10 m respectively, so that an included angle, for example, 9°, 18°, 27°, 36°, or 45° of a ray shot in each ray cluster may be calculated. Therefore, a ray orientation of each viewing-frustum ray may be determined based on a degree on the circle and the included angle of the ray.

Further, as shown in the right figure of FIG. 17, the M ray clusters may be shot toward each ray orientation. For example, as shown in the right figure of FIG. 17, ray clusters a, b, c, d, and e are shot toward 0°, 72°, 144°, 216°, and 288° respectively, and five concentric circles and 25 viewing-frustum rays evenly distributed on the concentric circles may be obtained. When a horizontal distance at which the 25 viewing-frustum rays are shot reaches the length threshold (10 m shown in the left figure of FIG. 17), cross-sectional distribution shown in the right figure of FIG. 17 may be obtained.

Further, if any viewing-frustum ray hits an object, object attribute information of the hit object may be returned. For example, when any viewing-frustum ray in the group of viewing-frustum rays (the group of viewing-frustum rays with the envelope surface in the cone shape shot from the head of the game character shown in the left figure of FIG. 17) hits an object, the viewing-frustum ray hitting the object returns object attribute information corresponding to a hit point to the server. For example, in the 3D FPS game shown in FIG. 16, a group of cone-shaped viewing-frustum rays (the group of viewing-frustum rays with the envelope surface in the cone shape shot from the head of the game character shown in the left figure of FIG. 17) are shot from the head of the game character, and when each viewing-frustum ray in the group of viewing-frustum rays shot from the simulated viewing-frustum visual angle reaches the length threshold (10 m shown in the left figure of FIG. 17), it is assumed that one viewing-frustum ray hits an object (a grassland shown in FIG. 16) at 10 m, and the viewing-frustum ray hitting the object returns object attribute information such as location information (for example, coordinates of a hit point on the currently hit grassland on a current picture in the 3D FPS game shown in FIG. 16) of the hit object corresponding to the hit point, category information (for example, ground of the grassland) of the hit object, and material information (for example, soil or a soft soil texture) of the hit object to the server.

After the information vector (for example, the information about the single ray shown in FIG. 15) of the single viewing-frustum ray is obtained based on the obtained object attribute information, the information vectors respectively corresponding to all the viewing-frustum rays hitting the object may be spliced in the preset fixed order. For example, splicing is performed in a counterclockwise order first and then in an outside-to-inside order, or splicing is performed in an inside-to-outside order first and then in a counterclockwise order. For that splicing is performed in the counterclockwise order first and then in the outside-to-inside order, it is assumed that the group of viewing-frustum rays shown in the right figure of FIG. 17 may be spliced in the counterclockwise order first. The ray cluster a may be spliced in a counterclockwise order starting from 0° of the rays in the cross-sectional distribution shown in the right figure of FIG. 17, to be specific, spliced in an order of a0, a1, a2, a3, and a4. Similarly, other ray clusters b, c, d, and e may be spliced in the counterclockwise order. Then, the other ray clusters b, c, d, and e may be spliced in the outside-to-inside order from the ray cluster a to the ray cluster e in the cross-sectional distribution shown in the right figure of FIG. 17, to obtain the basic ray-feature vector, so that the basic ray-feature vector may be inputted into the subsequent machine learning model subsequently, for the machine learning model to perform inductive learning on the extracted three-dimensional scene feature.

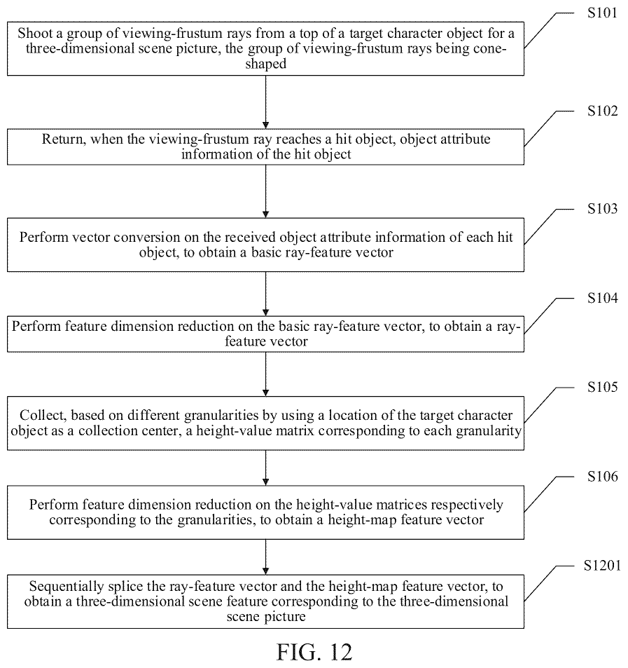

For example, in some embodiments, based on the embodiment corresponding to FIG. 2, in another exemplary embodiment of the feature extraction method for a three-dimensional scene provided in the embodiments of this application, as shown in FIG. 12, operation S107 of integrating the ray-feature vector and the height-map feature vector into the three-dimensional scene feature corresponding to the three-dimensional scene picture includes the following operation.

Operation S1201: Sequentially splice the ray-feature vector and the height-map feature vector, to obtain the three-dimensional scene feature corresponding to the three-dimensional scene picture.

In this embodiment of this application, after the ray-feature vector and the height-map feature vector are obtained, the ray-feature vector and the height-map feature vector may be sequentially spliced, to obtain the three-dimensional scene feature corresponding to the three-dimensional scene picture. The three-dimensional scene feature in a fixed feature order can be obtained, so that the machine learning model can better perform inductive learning based on the three-dimensional scene feature in the fixed feature order subsequently.

Specifically, as shown in FIG. 15, after the ray-feature vector and the height-map feature vector are obtained, the ray-feature vector and the height-map feature vector may be sequentially spliced. To be specific, as shown in FIG. 15, splicing is performed in an order from the ray-feature vector to the height-map feature vector, to obtain the three-dimensional scene feature corresponding to the three-dimensional scene picture. The three-dimensional scene feature may be provided for the machine learning model to perform inductive learning.

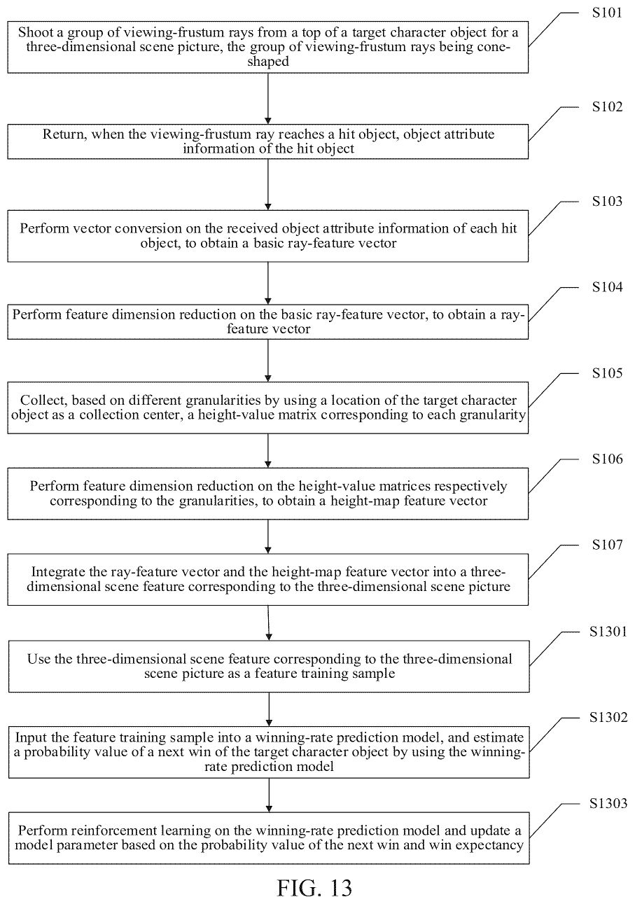

In some embodiments, based on the embodiment corresponding to FIG. 2, in another exemplary embodiment of the feature extraction method for a three-dimensional scene provided in the embodiments of this application, as shown in FIG. 13, after operation S107 of integrating the ray-feature vector and the height-map feature vector into the three-dimensional scene feature corresponding to the three-dimensional scene picture, the method further includes the following operations.

Operation S1301: Use the three-dimensional scene feature corresponding to the three-dimensional scene picture as a feature training sample.

Operation S1302: Input the feature training sample into a winning-rate prediction model, and estimate a probability value of a next win of the target character object by using the winning-rate prediction model.

Operation S1303: Perform reinforcement learning on the winning-rate prediction model and update a model parameter based on the probability value of the next win and win expectancy.

In this embodiment of this application, after the three-dimensional scene feature corresponding to the three-dimensional scene picture is obtained, the three-dimensional scene feature corresponding to the three-dimensional scene picture may be used as the feature training sample for the machine learning model. For example, when this embodiment is configured for extracting the three-dimensional scene feature of the three-dimensional game scene picture, the three-dimensional scene feature may be used as the feature training sample for the machine learning game AI to perform inductive learning. To be specific, the feature training sample may be inputted to the winning-rate prediction model, the probability value of the next win of the target character object is estimated by using the winning-rate prediction model, and then reinforcement learning is performed on the winning-rate prediction model and the model parameter is updated based on the probability value of the next win and the win expectancy, so that a winning rate of the game AI can be better planned based on a trained winning-rate prediction model subsequently.

Specifically, for the winning-rate prediction model, a policy πθ (at|st) may be used, which is represented by a deep neural network with a parameter θ. The winning-rate prediction model uses a previous observation and action st=o1: t, a1: t−1 received in a game, and a three-dimensional scene feature corresponding to each frame of three-dimensional scene picture as the feature training sample as an input of the model, and selects an action at as an output. A game environment is sensed internally based on the feature training sample. In addition, an observation result ot may be encoded through convolutional and fully connected layers, and then merged into a vector for representation. The vector is processed by a deep order network, and is finally mapped into probability distribution of the action, namely, the probability value of the next win of the target character object. Further, an expectation or value, namely, the win expectancy, may be obtained based on a state value function or an action value function. Then, reinforcement learning may be performed on the winning-rate prediction model and the model parameter may be updated based on an iterative algorithm, the probability value of the next win, and the win expectancy until the model converges, so that the winning rate of the game AI may be better planned based on the trained winning-rate prediction model subsequently.

After the three-dimensional scene feature corresponding to the three-dimensional scene picture is obtained, the three-dimensional scene feature corresponding to the three-dimensional scene picture may be used as the feature training sample for the machine learning model to perform inductive learning, or may be used in reinforcement learning such as level prediction, high score prediction, and obstacle prediction of another model, or may be used in supervised learning of another model. This is not specifically limited herein.

In this way, the machine learning model is learned based on using the three-dimensional scene feature that is concise, efficient, and semantically rich, and includes terrain landform information as the sample feature, so that the three-dimensional scene sensing capability of the machine learning model can be enhanced, thereby accelerating production and development of the machine learning model, and reducing learning costs of a machine learning task.

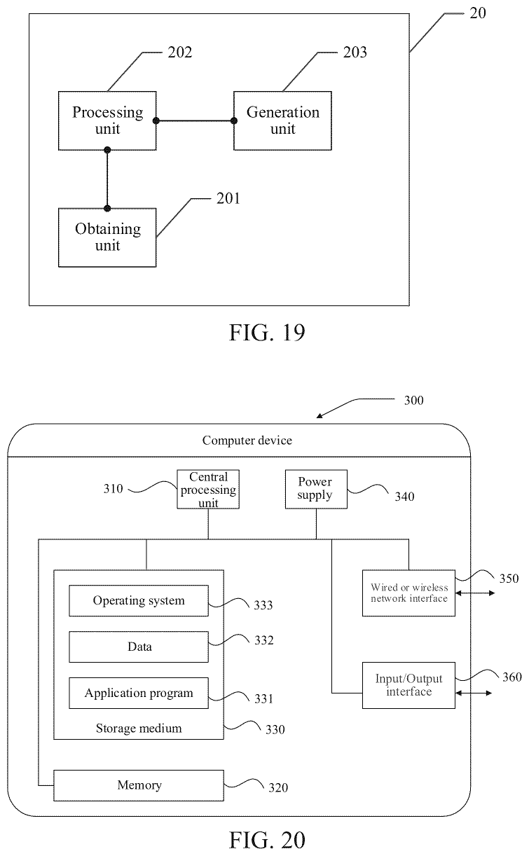

A feature extraction apparatus for a three-dimensional scene in this application is described in detail below. FIG. 19 is a schematic diagram of an embodiment of a feature extraction apparatus for a three-dimensional scene according to an embodiment of this application. The feature extraction apparatus 20 for a three-dimensional scene includes:
a processing unit 201, configured to shoot a group of viewing-frustum rays from a target character object for a three-dimensional scene picture, the group of viewing-frustum rays being cone-shaped;
an obtaining unit 202, configured to return, when the viewing-frustum ray reaches a hit object, object attribute information of the hit object;
the processing unit 201, further configured to perform vector conversion on the received object attribute information of each hit object, to obtain a basic ray-feature vector;
the processing unit 201, further configured to perform feature dimension reduction on the basic ray-feature vector, to obtain a ray-feature vector;
the processing unit 201, further configured to collect, based on different granularities by using a location of the target character object as a collection center, a height-value matrix corresponding to each granularity;
the processing unit 201, further configured to perform feature dimension reduction on the height-value matrices respectively corresponding to the granularities, to obtain a height-map feature vector; and a determining unit 203, further configured to integrate the ray-feature vector
and the height-map feature vector into a three-dimensional scene feature corresponding to the three-dimensional scene picture.

In some embodiments, based on the embodiment corresponding to FIG. 19, the object attribute information of the hit object includes location information, category information, and material information of the hit object. In another embodiment of the feature extraction apparatus for a three-dimensional scene provided in this embodiment of this application, the processing unit 201 may be specifically configured to:
perform, for each piece of object attribute information of the hit object, vector conversion on the location information, the category information, and the material information of the hit object included in the object attribute information, to obtain an information vector corresponding to the viewing-frustum ray reaching the hit object; and
integrate the information vectors respectively corresponding to the viewing-frustum rays into the basic ray-feature vector.

In some embodiments, based on the embodiment corresponding to FIG. 19, in another embodiment of the feature extraction apparatus for a three-dimensional scene provided in this embodiment of this application, the processing module 201 may be specifically configured to:
perform vector normalization on the location information of the hit object, to obtain a location vector;
perform feature encoding on the category information and the material information of the hit object, to obtain an encoded vector; and
splice the location vector and the encoded vector, to obtain the information vector corresponding to the viewing-frustum ray reaching the hit object; and
the processing unit 201 may be specifically configured to: sequentially splice the information vectors respectively corresponding to the viewing-frustum rays, to obtain the basic ray-feature vector.

In some embodiments, based on the embodiment corresponding to FIG. 19, in another embodiment of the feature extraction apparatus for a three-dimensional scene provided in this embodiment of this application, the processing module 201 may be specifically configured to:
collect, based on the different granularities by using the location of the target character object as the collection center, N*N surrounding grids corresponding to each granularity, N being an integer greater than 1; and
generate the height-value matrix corresponding to each granularity based on the N*N grids corresponding to each granularity.

In some embodiments, based on the embodiment corresponding to FIG. 19, in another embodiment of the feature extraction apparatus for a three-dimensional scene provided in this embodiment of this application, the processing module 201 may be specifically configured to:
use the different granularities as unit lengths of to-be-collected grids of different sizes; and
collect, based on the unit lengths of the to-be-collected grids of different sizes by using the location of the target character object as the collection center, N*N surrounding grids corresponding to each unit length of the to-be-collected grids; and
the processing unit may be specifically configured to: obtain a height value corresponding to a center point of each grid in the N*N grids, and generate, based on the height value, the height-value matrix corresponding to the granularity corresponding to the N*N grids.

In some embodiments, based on the embodiment corresponding to FIG. 19, in another embodiment of the feature extraction apparatus for a three-dimensional scene provided in this embodiment of this application, the processing module 201 may be specifically configured to:
splice the height-value matrices respectively corresponding to the granularities and perform tensor conversion, to obtain a height-map feature tensor; and
perform feature dimension reduction on the height-map feature tensor, to obtain the height-map feature vector.

In some embodiments, based on the embodiment corresponding to FIG. 19, in another embodiment of the feature extraction apparatus for a three-dimensional scene provided in this embodiment of this application, the processing module 201 may be specifically configured to:
perform feature dimension reduction on the basic ray-feature vector by using a neural network, to obtain the ray-feature vector; and

Perform, by using a neural network, feature dimension reduction on the height-value matrices respectively corresponding to the granularities, to obtain the height-map feature vector.

In some embodiments, based on the embodiment corresponding to FIG. 19, the neural network configured for performing feature dimension reduction on the basic ray-feature vector and the neural network configured for performing feature dimension reduction on the height-value matrices respectively corresponding to the granularities are a same convolutional neural network. In another embodiment of the feature extraction apparatus for a three-dimensional scene provided in this embodiment of this application, the processing unit 201 may be specifically configured to:
perform feature dimension reduction on the basic ray-feature vector by using the convolutional neural network, to obtain the ray-feature vector; and
the processing unit 201 may be specifically configured to perform, by using the convolutional neural network, feature dimension reduction on the height-value matrices respectively corresponding to the granularities, to obtain the height-map feature vector.

In some embodiments, based on the embodiment corresponding to FIG. 19, the neural network includes a first neural network and a second neural network, and the first neural network and the second neural network are different neural networks. In another embodiment of the feature extraction apparatus for a three-dimensional scene provided in this embodiment of this application, the processing unit 201 may be specifically configured to:
perform feature dimension reduction on the basic ray-feature vector by using the first neural network, to obtain the ray-feature vector; and
the processing unit 201 may be specifically configured to perform, by using the second neural network, feature dimension reduction on the height-value matrices respectively corresponding to the granularities, to obtain the height-map feature vector.

In some embodiments, based on the embodiment corresponding to FIG. 19, in another embodiment of the feature extraction apparatus for a three-dimensional scene provided in this embodiment of this application, the processing module 201 may be specifically configured to:
simulate a viewing-frustum visual angle and shoot the group of viewing-frustum rays from a top of the target character object; and
the obtaining unit 202 may be specifically configured to: return, if any viewing-frustum ray reaches the hit object after each viewing-frustum ray shot from the simulated viewing-frustum visual angle reaches a length threshold, the object attribute information of the hit object.

In some embodiments, based on the embodiment corresponding to FIG. 19, in another embodiment of the feature extraction apparatus for a three-dimensional scene provided in this embodiment of this application, the processing module 201 may be specifically configured to:
obtain p evenly distributed ray orientations by using the top of the target character object as a center of a circle, and shoot M ray clusters to each ray orientation, an envelope surface of the M ray clusters being cone-shaped, each ray cluster including p viewing-frustum rays, the p viewing-frustum rays of each ray cluster being evenly distributed on M concentric circles, p being an integer greater than 2, and M being an integer greater than or equal to 1; and
the obtaining unit 202 may be specifically configured to: return, if any viewing-frustum ray reaches the hit object after the p viewing-frustum rays in each ray cluster in the M ray clusters reach the length threshold, the object attribute information of the hit object.

In some embodiments, based on the embodiment corresponding to FIG. 19, in another embodiment of the feature extraction apparatus for a three-dimensional scene provided in this embodiment of this application, the determining unit 203 may be specifically configured to:
sequentially splice the ray-feature vector and the height-map feature vector, to obtain the three-dimensional scene feature corresponding to the three-dimensional scene picture.

In a possible design, in an implementation of another aspect of this embodiment of this application,
the determining unit 203 is further configured to use the three-dimensional scene feature corresponding to the three-dimensional scene picture as a feature training sample;
the processing unit 201 is further configured to input the feature training sample into a winning-rate prediction model, and estimate a probability value of a next win of the target character object by using the winning-rate prediction model; and
the processing unit 201 is further configured to perform reinforcement learning on the winning-rate prediction model and update a model parameter based on the probability value of the next win and win expectancy.

According to another aspect of this application, a schematic diagram of another computer device is provided. FIG. 20 is a schematic structural diagram of a computer device according to an embodiment of this application. The computer device 300 may vary greatly due to different configurations or performance, and may include one or more central processing units (CPU) 310 (for example, one or more processors), a memory 320, and one or more storage media 330 (for example, one or more mass storage devices) storing an application 331 or data 332. The memory 320 and the storage medium 330 may be transient or persistent storages. The program stored in the storage medium 330 may include one or more modules (not shown in the figure), and each module may include a series of instructions and operations for the computer device 300. Furthermore, the central processing unit 310 may be configured to communicate with the storage medium 330, and perform, on the computer device 300, the series of instructions and operations in the storage medium 330.

The computer device 300 may further include one or more power supplies 340, one or more wired or wireless network interfaces 350, one or more input/output interfaces 360, and/or one or more operating systems 333, for example, Windows Server™, Mac OS X™, Unix™, Linux™, and FreeBSD™.

The foregoing computer device 300 is further configured to perform the operations in the embodiments corresponding to FIG. 2 to FIG. 13.

According to another aspect of this application, a non-transitory computer-readable storage medium is provided, having a computer program stored therein, the computer program, when executed by a processor of a computer device, causing the computer device to implement operations of the method described in the embodiments shown in FIG. 2 to FIG. 13.

According to another aspect of this application, a computer program product including a computer program is provided, the computer program, when executed by a processor, implementing operations of the method described in the embodiments shown in FIG. 2 to FIG. 13.

Persons skilled in the art may clearly understand that, for the purpose of convenient and brief description, for a detailed working process of the system, apparatus, and unit described above, refer to a corresponding process in the method embodiments, and details are not described herein again.

In the several embodiments provided in this application, it is to be understood that the disclosed system, apparatus, and method may be implemented in other manners. For example, the described apparatus embodiments are only exemplary. For example, the division of the units is only a logical function division and may be other divisions during actual implementation. For example, a plurality of units or components may be combined or integrated into another system, or some features may be ignored or not performed. In addition, the shown or discussed mutual couplings or direct couplings or communication connections may be implemented through some interfaces. The indirect couplings or communication connections between the apparatus or units may be implemented in electronic, mechanical, or other forms.

The units described as separate parts may or may not be physically separate. Parts displayed as units may or may not be physical units, and may be located in one position, or may be distributed on a plurality of network units. Some or all of the units may be selected according to an actual requirement to achieve the objectives of the solutions in the embodiments.

In addition, functional units in the embodiments of this application may be integrated into one processing unit, or each of the units may exist alone physically, or two or more units are integrated into one unit. The integrated unit may be implemented in the form of hardware, or may be implemented in the form of a software function unit.

When the integrated unit is implemented in the form of a software functional unit and sold or used as an independent product, the integrated unit may be stored in a computer-readable storage medium. Based on such an understanding, the technical solutions of this application essentially, or the part contributing to the related art, or all or a part of the technical solutions may be implemented in the form of a software product. The computer software product is stored in a storage medium and includes several instructions for instructing a computer device (which may be a personal computer, a server, or a network device) to perform all or some of the operations of the method described in the embodiments of this application. The foregoing storage medium comprises: any medium that can store program code, such as a USB flash drive, a removable hard disk, a read-only memory (ROM), a RAM, a magnetic disk, a compact disc, or the like.

In sum, the term “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit can be implemented using one or more processors (or processors and memory). Likewise, a processor (or processors and memory) can be used to implement one or more units. Moreover, each unit can be part of an overall unit that includes the functionalities of the unit.

What is claimed is:

1. A feature extraction method for a three-dimensional scene performed by a computer device, the method comprising:
shooting a cone-shaped group of viewing-frustum rays from a target character object for a hit object in a three-dimensional scene picture;
determining object attribute information of the hit object based on an interaction between the viewing-frustum rays and the hit object;
performing vector conversion on the object attribute information of the hit object, to obtain a ray-feature vector;
collecting, based on different granularities by using a location of the target character object as a collection center, a height-value matrix corresponding to each granularity;
performing feature dimension reduction on the height-value matrices respectively corresponding to the granularities, to obtain a height-map feature vector; and
integrating the ray-feature vector and the height-map feature vector into a three-dimensional scene feature corresponding to the three-dimensional scene picture.

2. The method according to claim 1, wherein the object attribute information of the hit object comprises location information, category information, and material information of the hit object; and
the performing vector conversion on the object attribute information of the hit object, to obtain a ray-feature vector comprises:
performing, for each piece of object attribute information of the hit object, vector conversion on the location information, the category information, and the material information of the hit object comprised in the object attribute information, to obtain an information vector corresponding to the viewing-frustum ray reaching the hit object; and
integrating the information vectors respectively corresponding to the viewing-frustum rays into the ray-feature vector.

3. The method according to claim 1, wherein the collecting, based on different granularities by using a location of the target character object as a collection center, a height-value matrix corresponding to each granularity comprises:
collecting, based on the different granularities by using the location of the target character object as the collection center, N*N surrounding grids corresponding to each granularity, N being an integer greater than 1; and
generating the height-value matrix corresponding to each granularity based on the N*N grids corresponding to each granularity.

4. The method according to claim 1, wherein the performing feature dimension reduction on the height-value matrices respectively corresponding to the granularities, to obtain a height-map feature vector comprises:
splicing the height-value matrices respectively corresponding to the granularities and performing tensor conversion, to obtain a height-map feature tensor; and
performing feature dimension reduction on the height-map feature tensor, to obtain the height-map feature vector.

5. The method according to claim 1, wherein the shooting a cone-shaped group of viewing-frustum rays from a target character object comprises:
simulating a viewing-frustum visual angle and shooting the cone-shaped group of viewing-frustum rays from a top of the target character object; and
the determining object attribute information of the hit object based on an interaction between the viewing-frustum rays and the hit object comprises:
determining the object attribute information of the hit object when any viewing-frustum ray reaches the hit object after each viewing-frustum ray shot from the simulated viewing-frustum visual angle reaches a length threshold.

6. The method according to claim 1, wherein the integrating the ray-feature vector and the height-map feature vector into a three-dimensional scene feature corresponding to the three-dimensional scene picture comprises:
sequentially splicing the ray-feature vector and the height-map feature vector, to obtain the three-dimensional scene feature corresponding to the three-dimensional scene picture.

7. The method according to claim 1, wherein the method further comprises:
inputting the three-dimensional scene feature into a winning-rate prediction model, and estimating a probability value of a next win of the target character object by using the winning-rate prediction model; and
performing reinforcement learning on the winning-rate prediction model and updating a model parameter based on the probability value of the next win and win expectancy.

8. A computer device, comprising a memory, and a processor, the memory having a computer program stored therein, the computer program, when executed by the processor, causing the computer device to implement a feature extraction method for a three-dimensional scene including:
shooting a cone-shaped group of viewing-frustum rays from a target character object for a hit object in a three-dimensional scene picture;
determining object attribute information of the hit object based on an interaction between the viewing-frustum rays and the hit object;
performing vector conversion on the object attribute information of the hit object, to obtain a ray-feature vector;
collecting, based on different granularities by using a location of the target character object as a collection center, a height-value matrix corresponding to each granularity;
performing feature dimension reduction on the height-value matrices respectively corresponding to the granularities, to obtain a height-map feature vector; and
integrating the ray-feature vector and the height-map feature vector into a three-dimensional scene feature corresponding to the three-dimensional scene picture.

9. The computer device according to claim 8, wherein the object attribute information of the hit object comprises location information, category information, and material information of the hit object; and
the performing vector conversion on the object attribute information of the hit object, to obtain a ray-feature vector comprises:
performing, for each piece of object attribute information of the hit object, vector conversion on the location information, the category information, and the material information of the hit object comprised in the object attribute information, to obtain an information vector corresponding to the viewing-frustum ray reaching the hit object; and
integrating the information vectors respectively corresponding to the viewing-frustum rays into the ray-feature vector.

10. The computer device according to claim 8, wherein the collecting, based on different granularities by using a location of the target character object as a collection center, a height-value matrix corresponding to each granularity comprises:
collecting, based on the different granularities by using the location of the target character object as the collection center, N*N surrounding grids corresponding to each granularity, N being an integer greater than 1; and
generating the height-value matrix corresponding to each granularity based on the N*N grids corresponding to each granularity.

11. The computer device according to claim 8, wherein the performing feature dimension reduction on the height-value matrices respectively corresponding to the granularities, to obtain a height-map feature vector comprises:
splicing the height-value matrices respectively corresponding to the granularities and performing tensor conversion, to obtain a height-map feature tensor; and
performing feature dimension reduction on the height-map feature tensor, to obtain the height-map feature vector.

12. The computer device according to claim 8, wherein the shooting a cone-shaped group of viewing-frustum rays from a target character object comprises:
simulating a viewing-frustum visual angle and shooting the cone-shaped group of viewing-frustum rays from a top of the target character object; and
the determining object attribute information of the hit object based on an interaction between the viewing-frustum rays and the hit object comprises:
determining the object attribute information of the hit object when any viewing-frustum ray reaches the hit object after each viewing-frustum ray shot from the simulated viewing-frustum visual angle reaches a length threshold.

13. The computer device according to claim 8, wherein the integrating the ray-feature vector and the height-map feature vector into a three-dimensional scene feature corresponding to the three-dimensional scene picture comprises:
sequentially splicing the ray-feature vector and the height-map feature vector, to obtain the three-dimensional scene feature corresponding to the three-dimensional scene picture.

14. The computer device according to claim 8, wherein the method further comprises:
inputting the three-dimensional scene feature into a winning-rate prediction model, and estimating a probability value of a next win of the target character object by using the winning-rate prediction model; and
performing reinforcement learning on the winning-rate prediction model and updating a model parameter based on the probability value of the next win and win expectancy.

15. A non-transitory computer-readable storage medium, having a computer program stored therein, the computer program, when executed by a processor of a computer device, causing the computer device to implement a feature extraction method for a three-dimensional scene including:
shooting a cone-shaped group of viewing-frustum rays from a target character object for a hit object in a three-dimensional scene picture;
determining object attribute information of the hit object based on an interaction between the viewing-frustum rays and the hit object;
performing vector conversion on the object attribute information of the hit object, to obtain a ray-feature vector;
collecting, based on different granularities by using a location of the target character object as a collection center, a height-value matrix corresponding to each granularity;
performing feature dimension reduction on the height-value matrices respectively corresponding to the granularities, to obtain a height-map feature vector; and
integrating the ray-feature vector and the height-map feature vector into a three-dimensional scene feature corresponding to the three-dimensional scene picture.

16. The non-transitory computer-readable storage medium according to claim 15, wherein the collecting, based on different granularities by using a location of the target character object as a collection center, a height-value matrix corresponding to each granularity comprises:
collecting, based on the different granularities by using the location of the target character object as the collection center, N*N surrounding grids corresponding to each granularity, N being an integer greater than 1; and
generating the height-value matrix corresponding to each granularity based on the N*N grids corresponding to each granularity.

17. The non-transitory computer-readable storage medium according to claim 15, wherein the performing feature dimension reduction on the height-value matrices respectively corresponding to the granularities, to obtain a height-map feature vector comprises:
splicing the height-value matrices respectively corresponding to the granularities and performing tensor conversion, to obtain a height-map feature tensor; and
performing feature dimension reduction on the height-map feature tensor, to obtain the height-map feature vector.

18. The non-transitory computer-readable storage medium according to claim 15, wherein the shooting a cone-shaped group of viewing-frustum rays from a target character object comprises:
simulating a viewing-frustum visual angle and shooting the cone-shaped group of viewing-frustum rays from a top of the target character object; and
the determining object attribute information of the hit object based on an interaction between the viewing-frustum rays and the hit object comprises:
determining the object attribute information of the hit object when any viewing-frustum ray reaches the hit object after each viewing-frustum ray shot from the simulated viewing-frustum visual angle reaches a length threshold.

19. The non-transitory computer-readable storage medium according to claim 15, wherein the integrating the ray-feature vector and the height-map feature vector into a three-dimensional scene feature corresponding to the three-dimensional scene picture comprises:
sequentially splicing the ray-feature vector and the height-map feature vector, to obtain the three-dimensional scene feature corresponding to the three-dimensional scene picture.

20. The non-transitory computer-readable storage medium according to claim 15, wherein the method further comprises:
inputting the three-dimensional scene feature into a winning-rate prediction model, and estimating a probability value of a next win of the target character object by using the winning-rate prediction model; and
performing reinforcement learning on the winning-rate prediction model and updating a model parameter based on the probability value of the next win and win expectancy.
